(19) United States
(12) Patent Application Publication
(10) Pub. No.: US 2015/0026352 A1
(43) Pub. Date: Jan. 22, 2015

(54) METHOD AND SYSTEM FOR CDN EXCHANGE INTERCONNECTION

(71) Applicant: INTERDIGITAL PATENT HOLDINGS, INC., Wilmington, DE (US)

(72) Inventors: Xavier De Foy, Kirkland (CA); Hang Liu, North Potomac, MD (US); Serhad Doken, Chester Springs, PA (US); Shamim Akbar Rahman, Cote St. Luc (CA)

(21) Appl. No.: 14/382,522

(22) PCT Filed: Mar. 5, 2013
(86) PCT No.: PCT/US13/29028

§ 371 Date: Sep. 2, 2014

Related U.S. Application Data
(60) Provisional application No. 61/609,091, filed on Mar. 9, 2012.

(51) Int. Cl. H04L 29/08

(52) U.S. Cl. CPC H04L 67/141; H04L 67/16
USPC 709/228

(57) ABSTRACT

The disclosure pertains to CDNI interconnection at a global level. CDNXs are enhanced to provide logging services associated with bilateral or multilateral agreement with CDNs, where these CDNs are interconnected with other CDNs not using the same CDNX. Moreover, additional functions are added in CDNXs and CDN Interconnection protocols to support CDN capability advertisement, CDN peer discovery, and to bootstrap CDN Interconnection.

### RELATED APPLICATIONS

This application is a non-provisional of U.S. Provisional Patent Application No. 61/609,091, filed Mar. 9, 2012, which is incorporated herein fully by reference.

### BACKGROUND

In content delivery networks or content distribution networks (CDNs), content such as web pages (text, graphics, URLs and scripts), data files (software, documents), and large media files (e.g., video, audio), is copied and cached at numerous locations in a system of computers. A CDN may improve access to the content because a given user may retrieve the data from a closer location, or at least a more easily accessible location, thereby reducing latency, network congestion, and the use of network resources.

Currently one possible CDN Interconnection deployment scheme is a CDN Federation, which is based on one central CDN Exchange. All CDNs that are members of the federation are interconnected with the CDN exchange, for the request routing and logging part. Typically, all CDNs are interconnected with each other for control, request routing and metadata. A description of CDN Interconnection Interfaces is shown in FIG. 1, while a CDN Exchange Overview is provided in FIG. 2.

The following definitions are provided:

Content: Any form of digital data. One important form of Content with additional constraints on Distribution and Delivery is continuous media.

Content Delivery Network (CDN): Network infrastructure in which the network elements cooperate at layer 4 through layer 7 for more effective delivery of Content to User Agents. Typically, a CDN consists of a Request Routing system, a Distribution System (that includes a set of Surrogates), a Logging System, and a CDN control system.

Content Delivery Service Provider (CDSP): A service provider that operates a CDN.

Publisher (or Content Service Provider, CSP): An entity that provides a content service to an End User. A Publisher may own the Content made available as part of the Content Service or may license content rights from another party.

End User: The ‘real’ user of the system, typically a human, but may be some combination of hardware and/or software emulating a human

Authoritative CDN: An upstream CDN contracted by the Publisher for delivery by this CDN or by its downstream CDNs

Ingestion Interface: An interface between the Publisher and a CDN; it is used to upload content and metadata to the CDN.

CDNI Control Interface: An interface that allows initial secure connection setup and bootstrapping of other interfaces. Other functions include capability exchange and content purge and pre-positioning.

CDNI Request Routing Interface (RRI): An interface that allows the Request Routing system in interconnected CDNs to communicate to ensure that an end user request can be (re)directed from an upstream CDN to a surrogate in the downstream CDN, in particular, where selection responsibilities may be split across CDNs (for example the upstream CDN may be responsible for selecting the downstream CDN while the downstream CDN may be responsible for selecting the actual surrogate within that CDN).

CDNI Logging Interface: An interface used to exchange activity logs, for example, for charging purposes.

CDNI Metadata Interface: An interface to communicate content metadata that is relevant to the distribution of the content and have an inter-CDN scope. For example, geo-blocking information, availability (time) windows, access control mechanisms can be part of this CDNI Metadata.

IP Exchange (IPX) 301, as shown in FIG. 3, is developed by GSMA in order to provide a QoS-enabled private IP backbone interconnecting network operators 303, including Mobile and Fixed Network Operators 303a, Internet Access Providers 303b, Content Providers, and Content Delivery Networks. IPX providers 305 are interconnected with each other at inter-IPX points 307, such as the one provided by the Amsterdam Internet Exchange. IPX enables cascading payments between all involved network and IPX providers. IPX proposes several interconnection models, including bilateral (two networks that have a business agreement and exchange traffic over IPX) and multilateral (the only business agreement is between the network operator and the IPX provider).

The following definitions relating to IPX are provided:

IPX: IP Packet eXchange. The entity providing the IPX functions. In the interconnection context, IPX is used to mean an interconnection at the service level.

IPX Provider: A business entity (such as an IP Carrier) offering IP interconnect capability for one or more IPX services compliant with the IPX operation criteria and compliant with the defined Service Level Agreement (SLA) and interconnect agreement for that service.

Internet eXchange Point (IX or IXP): a physical infrastructure through which Internet service providers (ISPs) exchange Internet traffic between their networks.

### SUMMARY

Embodiments described herein include methods and systems that in various forms may provide for a global CDN interconnection enabling cascading payment. This may include interconnecting several CDN Exchanges together and enabling dynamic interconnections between CDNs not connected to the same CDNX. In various embodiments, the CDNs may be able to interconnect following either bilateral or multilateral models.

In one embodiment, an architecture is provided where CDN Exchanges are interconnected with each other and establish and maintain CDN federations dynamically. These federations may be characterized by the exchange of logs through the interconnected CDN Exchanges for settlement, whereas other CDNI signaling (e.g., request routing) is directly exchanged between the CDNs.

In further embodiments, interconnection between CDN Exchange (CDNXs) may be based on CDN Interconnection (e.g., Logging Interface, Control and Request Routing Interface). CDNXs, as well as the Control and Request Routing Interfaces (CDN-CDNX as well as CDNX-CDNX) are enhanced to support various functions described herein, including an enhanced CDNI Request Routing Interface that provides CDN Peer Discovery based on policy advertisement in the case where CDNs have multilateral agreements with a CDNX. In one embodiment, two message types are used including INTERCONNECTION_POLICY_ADVERTISEMENT and DISCOVER_PEER.

In some embodiments, an additional function may include enhanced CDNI Request Routing and Control Interface that provides CDN Interconnection Bootstrap in the case where CDNs have multilateral agreements with a CDNX. In one such embodiment, two new message types may be used, including INTERCONNECTION_POLICY_ADVERTISEMENT (e.g., a request routing feature) and INTERCONNECT_BOOTSTRAP (e.g., a control feature).

In still further embodiments, an enhanced CDNI Request Routing and Control Interface is provided to support CDN Interconnection Bootstrap in the case where a CDN has a bilateral agreement with another CDN. In one such embodiment, two new message types may be used: INTERCONNECTION_POLICY_ADVERTISEMENT and INTERCONNECT_BOOTSTRAP.

In still further embodiments, CDN Exchanges may be enhanced to support Peer Discovery and Interconnection Bootstrap and/or forwarding of logs to CDNs not directly interconnected with this CDNX. CDNXs may create and maintain Bilateral and Multilateral Discovery Entries based on advertisements, which may be used for peer discovery and to make forwarding decision for bootstrap messages.

In some embodiments, CDNXs may create and maintain Interconnection Descriptors based on advertisements and bootstrap messages, which are used for the proper forwarding of logs.

In still further embodiments, Peer Discovery and Interconnection Bootstrap methods may be used to enable interconnection between CDNs that are interconnected with different CDNXs, when these CDNXs are interconnected directly or through one or more other CDNXs. Moreover, these methods may also be used when the CDNs are interconnected with the same CDNX.

### BRIEF DESCRIPTION OF THE DRAWINGS

A more detailed understanding may be had from the following description, given by way of example in conjunction with the accompanying drawings wherein:

FIG. 1 is a description of CDN interconnection interfaces;

FIG. 2 is a description of a CDN Exchange overview;

FIG. 3 depicts a Overview of IP Exchange;

FIG. 4A is a system diagram of an example communications system in which one or more disclosed embodiments may be implemented;

FIG. 4B is a system diagram of an example wireless transmit/receive unit (WTRU) that may be used within the communications system illustrated in FIG. 12A; and,

FIGS. 4C, 4D, and 4E are system diagrams of example radio access networks and example core networks that may be used within the communications system illustrated in FIG. 12A.

FIG. 5 depicts a CDN Exchange interconnection overview;

FIG. 6 illustrates a CDNX interconnection architecture overview;

FIG. 7 is an overview of an example peer discovery process;

FIG. 8 depicts an overview of CDNX assisted interconnection bootstrap;

FIGS. 9A-9B is an example of logs forwarding over the CDNI logging interface;

FIGS. 10A-10B is an example of multiple inter-CDNX paths; and,

FIG. 11 shows a bilateral CNDI session establishment.

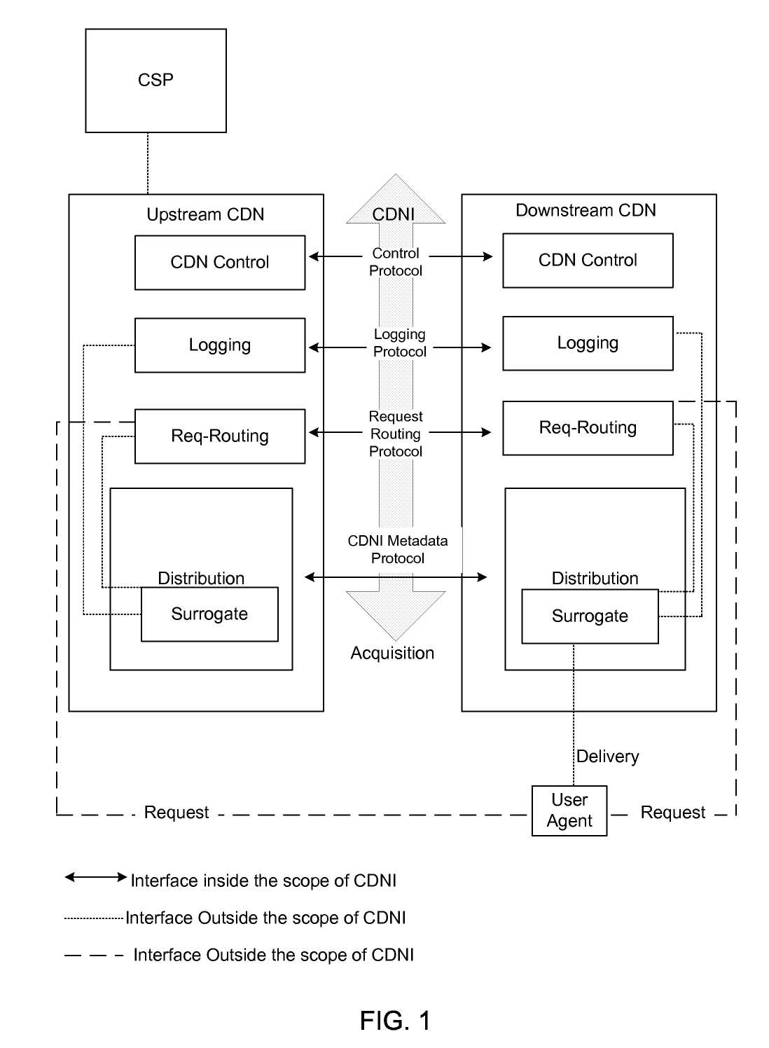

### DETAILED DESCRIPTION

Disclosed herein are methods and systems for global CDN interconnections and for enabling cascading payment. This may include interconnecting several CDN Exchanges together, and enabling dynamic interconnections between CDNs not connected to the same CDNX. In various embodiments, the CDNs may be able to interconnect following either bilateral or multilateral models. In one embodiment, an architecture is provided where CDN Exchanges are interconnected with each other and establish and maintain CDN federations dynamically. These federations may be characterized by the exchange of logs through the interconnected CDN Exchanges for settlement, whereas other CDNI signaling (e.g., request routing) is directly exchanged between the CDNs.

In further embodiments, interconnection between CDN Exchanges (CDNXs) may be based on CDN Interconnection (e.g., Logging Interface, Control and Request Routing Interface, as defined in IETF CDNI) CDNXs, as well as the Control and Request Routing Interfaces (both CDN-CDNX and CDNX-CDNX) are enhanced to support various functions described herein, including an enhanced CDNI Request Routing Interface that provides CDN Peer Discovery based on policy advertisement in the case where CDNs have multilateral agreements with a CDNX. In one embodiment, two message types are used, including INTERCONNECTION_POLICY_ADVERTISEMENT and DISCOVER_PEER.

In some embodiments, an additional function may include enhanced CDNI Request Routing and Control Interface, which provides CDN Interconnection Bootstrap in the case where CDNs have multilateral agreements with a CDNX. In one such embodiment, two new message types may be used, including INTERCONNECT_BOOTSTRAP (e.g., a control interface type message) and the aforementioned INTERCONNECTION_POLICY_ADVERTISEMENT (e.g., a request routing interface type message).

In still further embodiments, enhanced CDNI Request Routing and Control Interfaces are provided to support CDN Interconnection Bootstrap in the case where CDNs have bilateral agreements with another CDN. In one such embodiment, two new message types may be used: the INTERCONNECTION_POLICY_ADVERTISEMENT and INTERCONNECT_BOOTSTRAP messages.

The INTERCONNECTION_POLICY_ADVERTISEMENT messages used to implement the various functions as discussed herein may be essentially the same message type, but with differing information elements depending on the function. For example, we may use the term multilateral or bilateral interconnection policy advertisements, when applicable, to distinguish between two essentially similar messages that may contain different information elements (IEs). Likewise, the INTERCONNECT_BOOTSTRAP messages mentioned herein and used to implement the various functions as discussed herein also may be essentially the same message type, but with differing information elements depending on the context.

In still further embodiments, a CDNX may be enhanced to support Peer Discovery and Interconnection Bootstrap as well as forwarding of logs to CDNs not directly connected to the CDNX. CDNXs may create and maintain Bilateral and Multilateral Discovery Entries based on advertisements, which may be used for peer discovery and to make forwarding decisions for bootstrap messages.

As alluded to above, the three different INTERCONNECTION_POLICY_ADVERTISEMENT messages mentioned above and the two different INTERCONNECT_BOOTSTRAP messages mentioned above may be essentially the same types of messages, though they may hold slightly different information elements depending on its purpose. For instance, the INTERCONNECTION_POLICY_ADVERTISEMENT message can hold (among other things) a list of bilateral CDN peers in the bilateral case, and costs information in the multilateral case (or as noted further below in this specification, it also is envisioned that a single INTERCONNECTION_POLICY_ADVERTISEMENT message could hold both multilateral and bilateral information).

The INTERCONNECT_BOOTSTRAP message typically would contain the same IEs both the bilateral and multilateral contexts.

In some embodiments, CDNXs may create and maintain Interconnection Descriptors based on advertisements and bootstrap messages, which are used for the proper forwarding of logs.

In still further embodiments, the Peer Discovery and Interconnection Bootstrap methods may be used to enable interconnection between CDNs that are interconnected with different CDNXs when these CDNXs are interconnected directly or through one or more other CDNXs. Moreover, these methods also may be used when the CDNs are interconnected with the same CDNX.

Various network connections described herein may include wireless connections, and various elements of the CDN interconnection network may be deployed within a service provider's mobile network infrastructure.

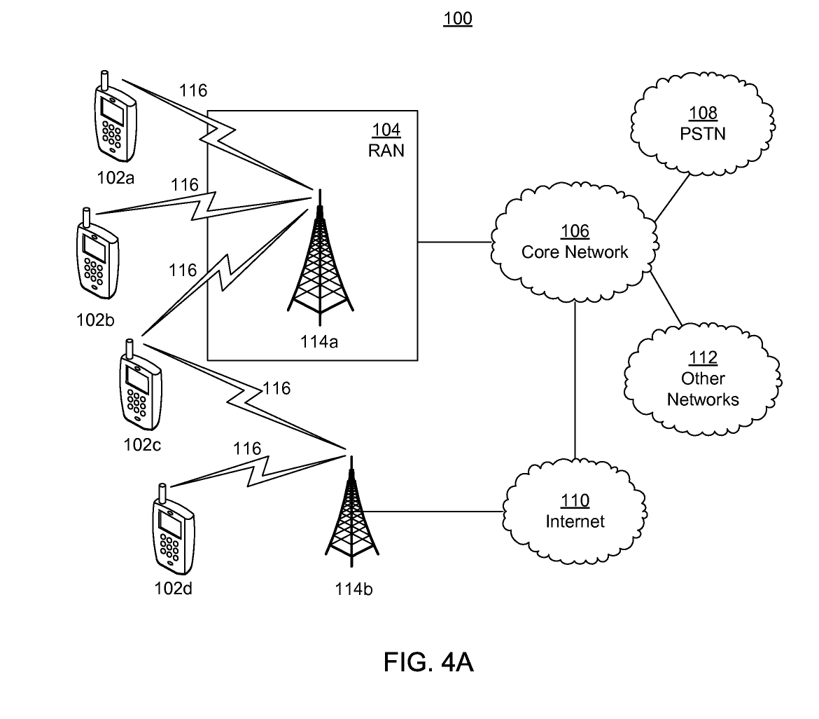

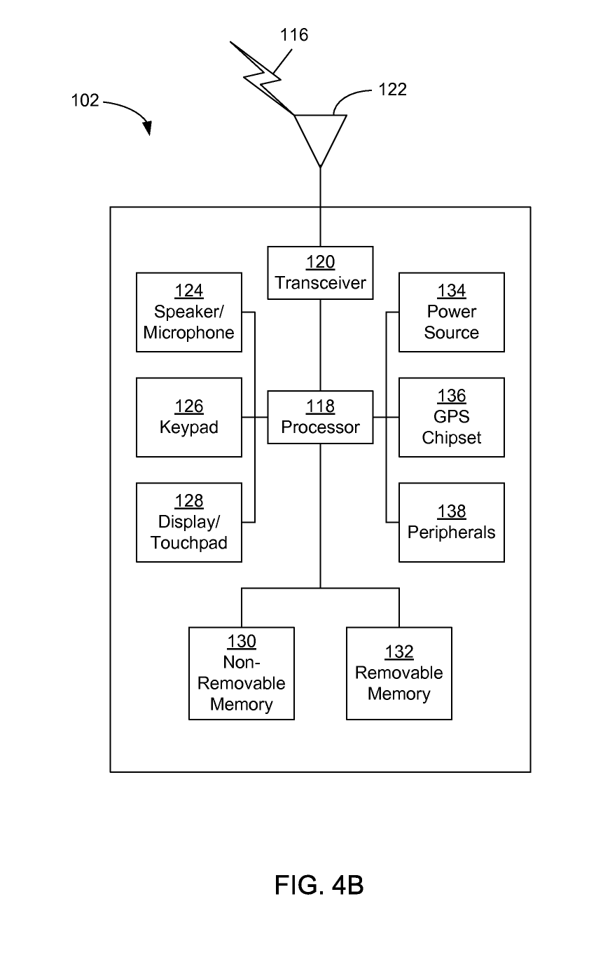

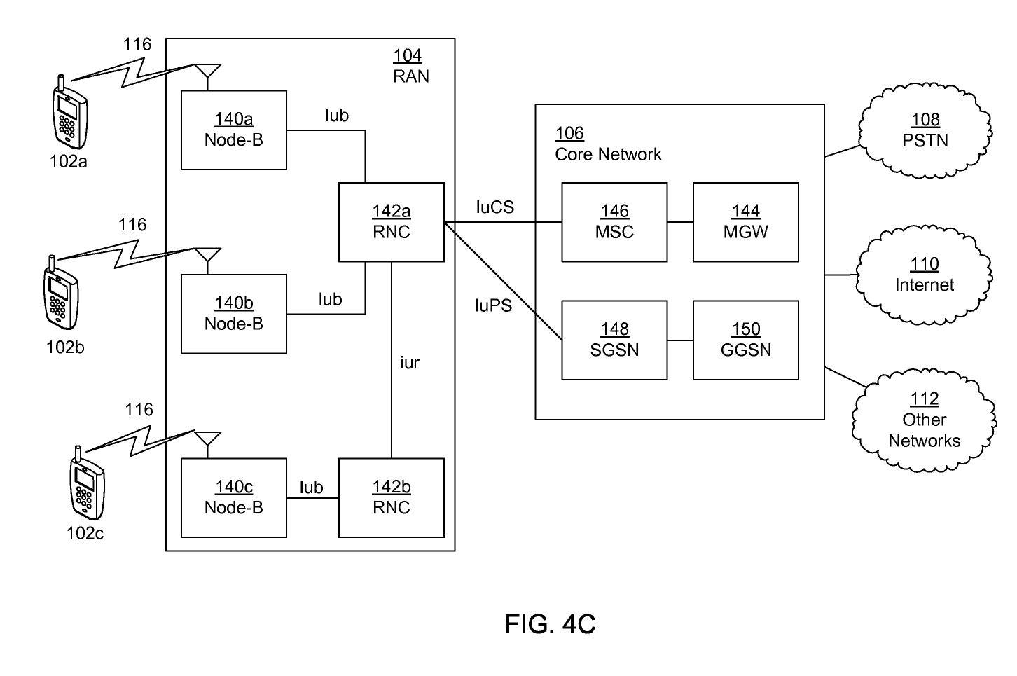

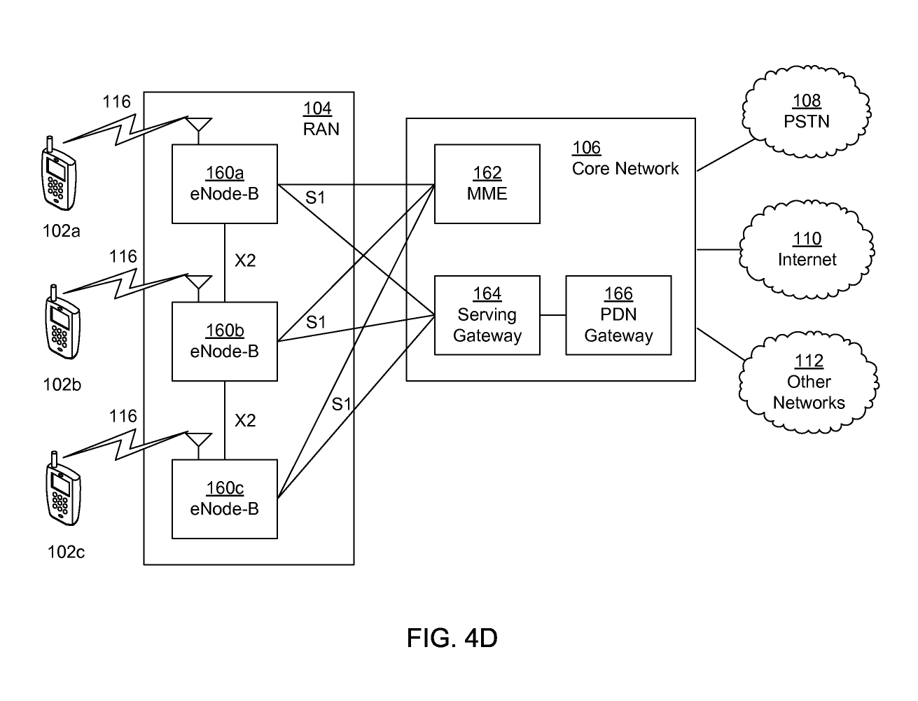

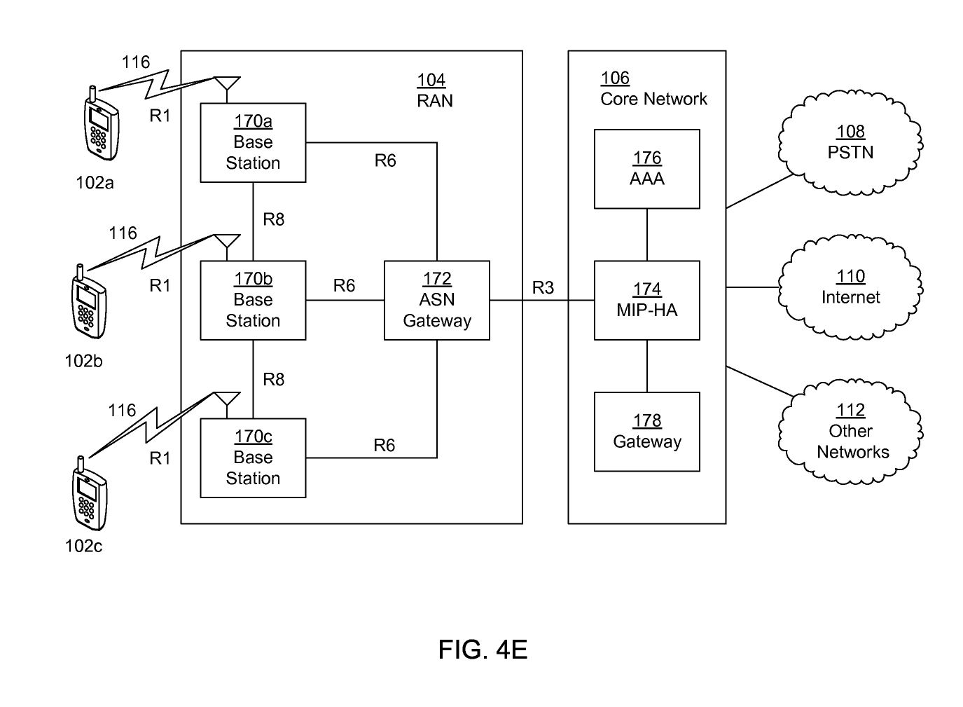

For instance, FIG. 4A is a diagram of an example wireless communications system 100 which may form a part of a global CDN federation in accordance with one or more disclosed embodiments. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 4A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 4A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 4A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 4A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 4A may be configured to communicate with the base station 114a, which may employ a cellular-based radio technology, and with the base station 114b, which may employ an IEEE 802 radio technology.

FIG. 4B is a system diagram of an example WTRU 102. As shown in FIG. 4B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 4B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 4B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 4C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 4C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 4C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 4C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 4D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 4D, the eNode-Bs 160a, 160b, 160c may communicate with one another over an X2 interface.

The core network 106 shown in FIG. 4D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 4E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 4E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 4E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 4E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

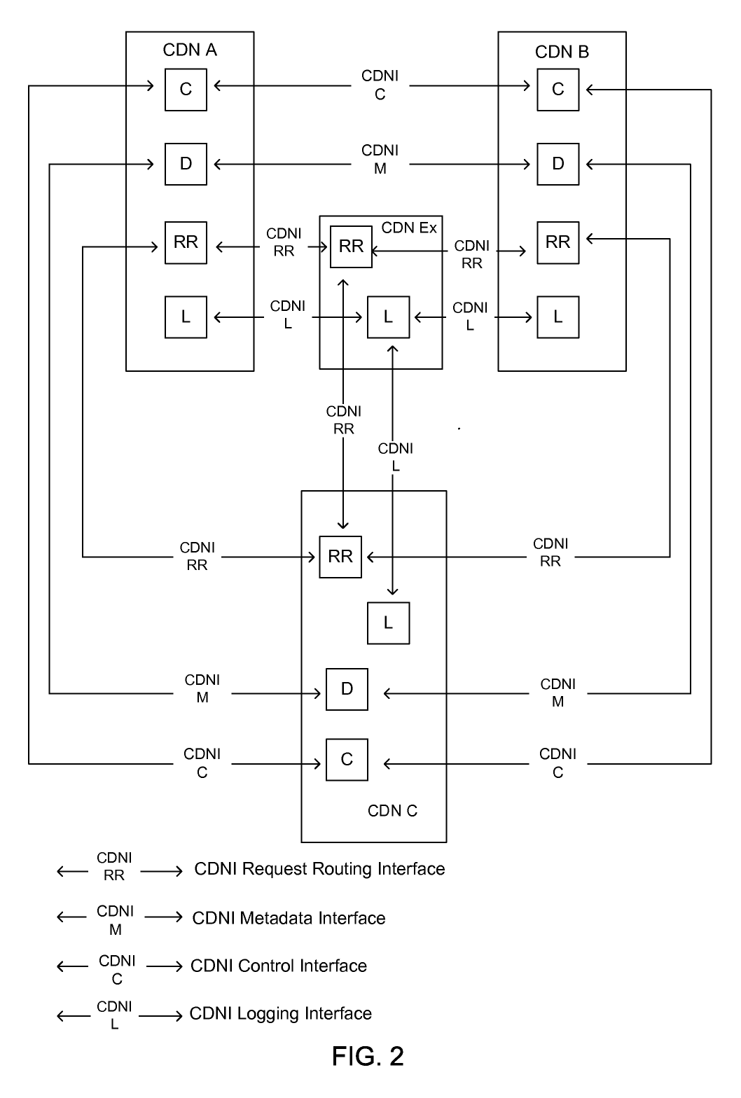

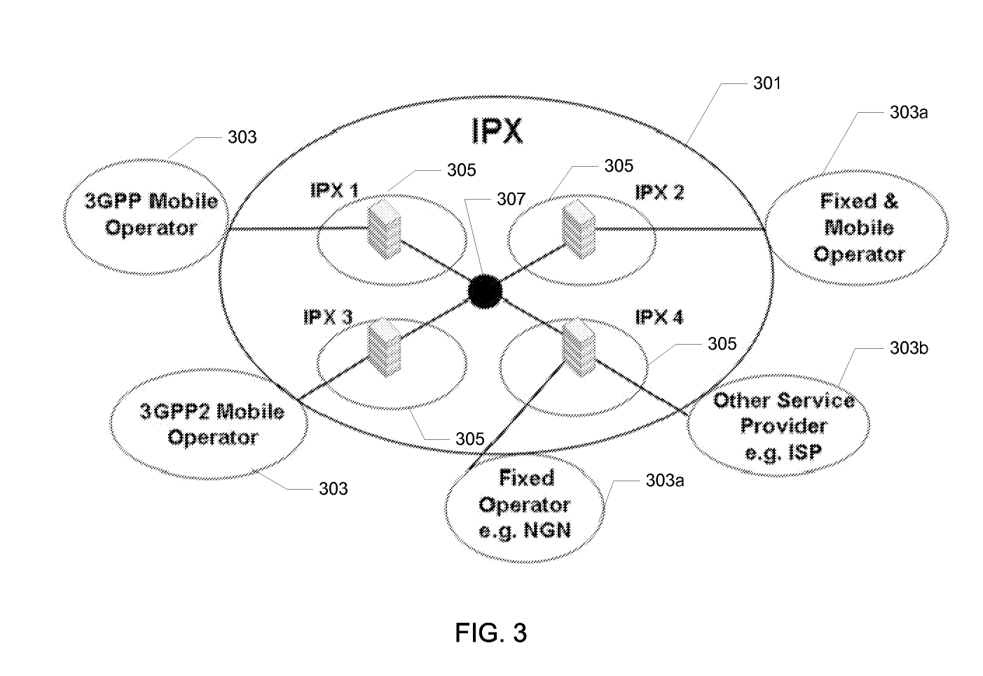

Returning now to CDN federations, in some systems, the CDN Exchange is a potential single point of failure or bottleneck. Moreover, CDN interconnection currently requires some form of business agreement, and currently envisioned federations require CDN Interconnection between every CDN involved in the federation. The CDN Exchanges (CDNXs) introduced in FIG. 2 are used to facilitate CDNI interconnection at a global level. CDNXs are enhanced to provide logging services associated with bilateral or multilateral agreement with CDNs, where these CDNs are interconnected with other CDNs not using the same CDNX. Moreover, additional functions are added in CDNXs and CDN Interconnection protocol to support CDN capability advertisement, CDN peer discovery, and to bootstrap a CDN Interconnection. Two signaling paths may be set up between first and second CDNs, and both may be based on CDNI signaling. The first signaling path is a Direct Interconnection between the two CDNs, which is used to route end user content requests, to exchange CDNI metadata, and for control signaling. The second signaling path between the two CDNs passes through one or more CDN Exchanges (CDNXs) and is used to discover (or be discovered by) a CDN peer, to bootstrap the direct interconnection between the two CDNs, and to exchange logs after the direct interconnection is up and running. This second signaling path is established over existing CDN-CDNX and CDNX-CDNX interconnections, as described below: The indirect interconnection through a CDNX may exist over several direct interconnections, which may be of two types, as described below.

CDN-CDNX interconnections typically represent a customer to service provider relationship. The CDN connects to the CDNX and expects to obtain the services mentioned above (e.g., discovering/being discovered, bootstrap and log exchange). The CDN operator may (and commonly does) pay the CDNX operator for the services.

CDNX-CDNX interconnections typically represent a peering relationship between service providers. Just as in relationships between ISPs, some CDNX interconnection may be free peering, while, in other cases, one side may receive payment for the connection.

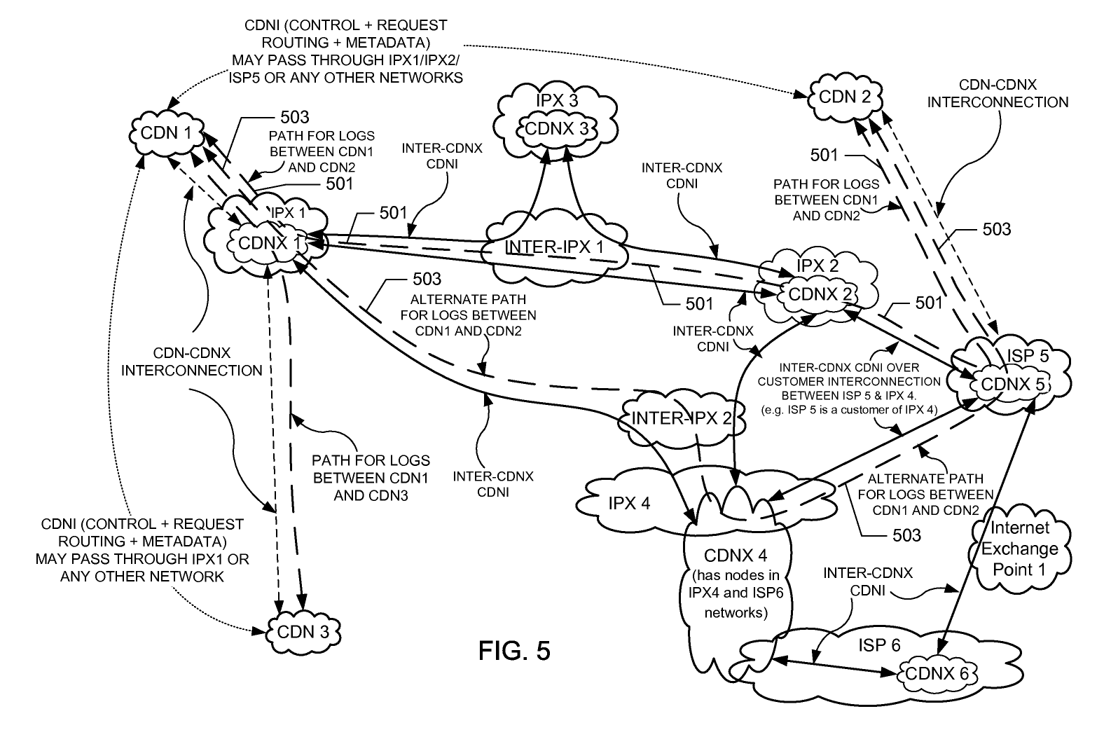

As shown in the CDN Exchange Interconnection Overview of FIG. 5, CDN 1 and CDN 2 are interconnected with different CDNXs, deployed by different types of IP Connectivity Providers. Specifically, exemplary CDN 1 is interconnected with CDNX 1, which is operated by exemplary service provider IPX 1, while exemplary CDN 2 is interconnected with CDNX 5, which is operated by exemplary service provider ISP 5. Multiple choices are available to interconnect CDNX 1 and CDNX 5. CDNXs are interconnected and form a mesh network, where interconnection points are located for example in Inter-IPX (e.g., CDNX 1-CDNX 2), Internet Exchange points (e.g., CDNX 5-CDNX 6), IPX customer entry points (e.g., CDNX 5-CDNX 4), or private interconnection inside the same ISP (e.g., CDNX 6-CDNX 4 being at least partially inside ISP 6). Specifically, a CDNX may span over several IP connectivity providers' networks. For example, CDNX 4 provides at least one entry point in ISP 6 and at least another one in IPX 4. There are three types of interconnections shown in FIG. 5. All of them may be based on CDNI protocol. First, CDN-CDNX interconnections are used for CDNs to send and receive CDNI logs, and also for advertisement, discovery, and bootstrapping of a CDN-CDN interconnection. Second, CDNX-CDNX interconnections are used to forward logs and also for advertisement, discovery, and bootstrap. Third, CDN-CDN interconnections are regular CDN Interconnection used, for example, for control, request routing, and metadata.

Arrows indicate two alternate paths for logs associated with the CDN 1-CDN 2 interconnection. The first path 501 is CDN 1-CDNX 1-CDNX 2-CDNX 5-CDN 2. The second path 503 is CDN 1-CDNX 1-CDNX 4-CDNX 5-CDN 2. In one embodiment, one of the two paths may be selected and used. In an alternate embodiment both paths may be selected and used concurrently.

For example, a CDN can enter into a multilateral agreement with a CDNX in North America, and may thereby interconnect with many CDNs around the world, and yet only directly exchange payments with the operator of that single CDNX. In a further embodiment, a CDN may enter into a bilateral agreement with another CDN. These CDNs may be interconnected with different CDNXs, but, due to the CDNXs' interconnection, they can use CDNXs for log exchange.

Although not illustrated in FIG. 5, it also should be understood that a single CDN could have a direct connection with two or more CDNXs simultaneously.

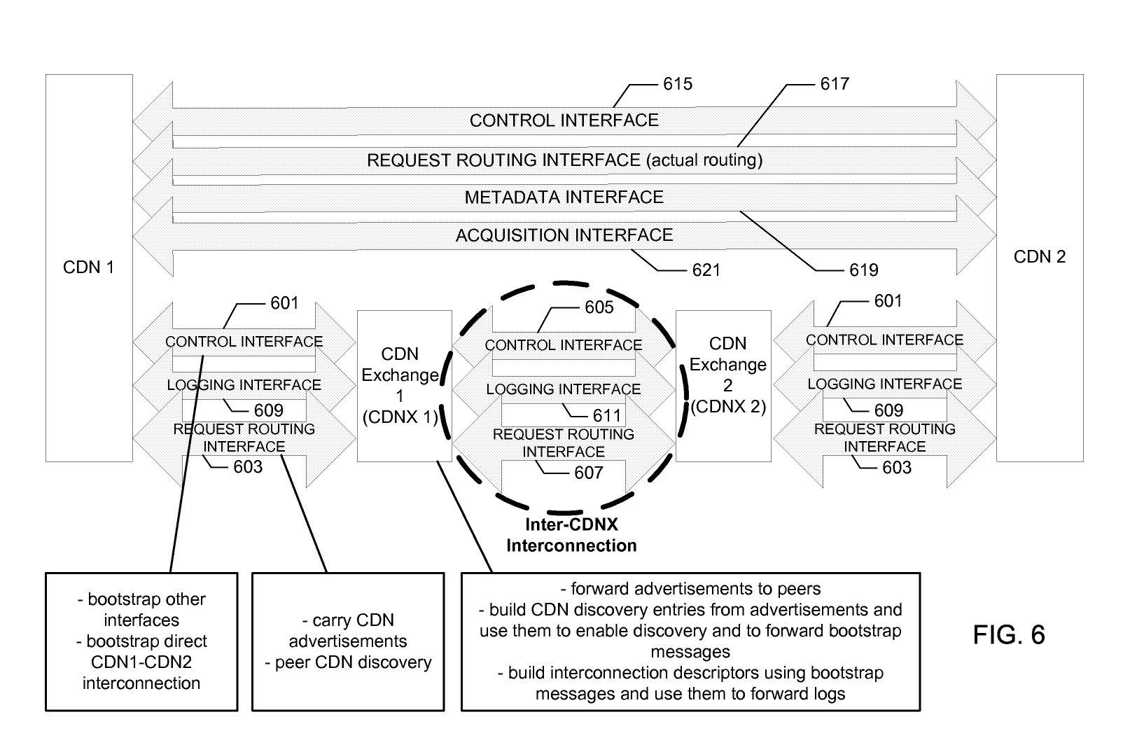

A CDNX may be deployed by an IP Connectivity Provider (e.g., IPX, ISP), by a CDN operator (e.g., Level3), or by a data center operator (e.g., Google). A CDNX may be a single node or a distributed set of nodes. FIG. 6 is a CDNX Interconnection Architecture Overview showing connectivity between a first CDN, CDN 1, and a second CDN, CDN 2, each interconnected with a different CDNX, namely, CDNX 1 and CDNX 2, respectively. As shown in FIG. 6, the CDNX-CDN Control Interfaces 601, CDNX-CDN Request Routing Interfaces 603, CDNX-CDNX Control Interface 605, and CDNX-CDNX Request Routing Interface 607 are enhanced to support Peer Discovery (which may be implemented as a CDNI request routing interface function) and Interconnection Bootstrap (which may be implemented as a CDNI control interface function). The CDN Exchanges (CDNX 1 and CDNX 2) are enhanced to support Peer Discovery, Interconnection Bootstrap, and forwarding and filtering of logs between CDN 1 and CDN 2.

In one embodiment, the CDNXs support multilateral agreements, e.g., where CDN 1 enters into a multilateral agreement with CDNX 1, and sets up an interconnection between the two entities. The following procedures may be used:

CDN 1 can advertise its capabilities, footprint, and costs through CDNX 1 as conditions for peering; thereafter, it can be discovered by other CDNs. On the other hand, CDN 1 can discover suitable peer CDNs through CDNX 1. CDN 1 can initiate an interconnection with CDN 2, where CDN 2 is not directly interconnected with CDNX 1. CDN 1 initiates a bootstrap procedure through CDNX 1; once this procedure is performed, CDN 1 can initiate a direct interconnection with CDN 2. Logs between CDN 1 and CDN 2 may be exchanged through Logging Interfaces 609, 611 between the CDNs and CDNXs (609) and between CDNXs (611). This enables cascading payments through CDNXs.

Further embodiments may include dynamic path for logs through the CDNX inter-network, pull vs. push model for CDN-CDNX interconnection, and the level of automation inside CDNs and CDNXs.

The aforementioned Direct Interconnection signaling path between two CDNs that is used to route end user content requests, to exchange CDNI metadata, and for control signaling also is represented in FIG. 6 by control interface 615, request routing interface 617, and metadata interface 619. The acquisition interface 621 shown in FIG. 6 represents the acquisition and distribution of the actual content objects.

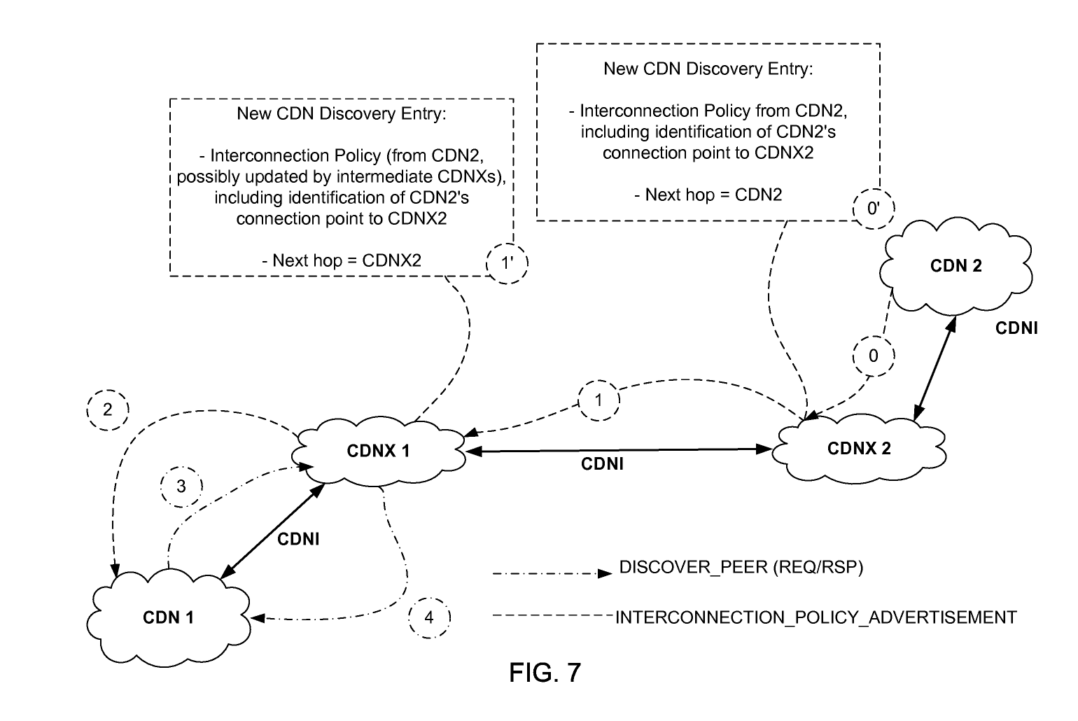

In one embodiment supporting multilateral agreements, CDNX assisted peer discovery is used. An overview of one example of a DISCOVER_PEER process is shown in FIG. 7. At interconnection time, CDN 2 may advertise its Interconnection Policy to CDNX 2 using an INTERCONNECTION_POLICY_ADVERTISEMENT message, as shown at 0 in FIG. 7. The INTERCONNECTION_POLICY_ADVERTISEMENT message is discussed in more detail below. Note that CDN 1 may advertise as well, but this is not shown in FIG. 7. CDNX 2 may create a CDN Discovery Entry, as shown in (0′). CDNX 2 may send a response to CDN 2, but response messages are omitted in the diagrams unless there are aspects worthy of clarification, such as when they may carry information other than a status code.

After reception of the INTERCONNECTION_POLICY_ADVERTISEMENT message, CDNX 2 may propagate this policy setting to other CDNXs, as shown by advertisement message 1 from CDNX 2 to CDNX 1. CDNX 2 may update the advertisement, for example adding additional cost information (e.g., cost for using CDNX 2's interconnection service). The CDNX 2 operator may choose to advertise different costs to different CDNX peers, or not to advertise to some CDNX peers.

As shown at 1′, upon reception and acceptance of the advertisement, CDNX 1 may create and store an internal data structure, referred to herein as a CDN “Discovery Entry”. This Discovery Entry may be used for CDN peer discovery (e.g., upon receiving a peer discovery request, CDNX 1 checks its discovery entries to find a matching CDN). In one embodiment, this entry also may associate a “next hop” (CDN identifier or CDNI-ID) to the advertised interconnection policy. The next hop information may later be used to bootstrap the CDN interconnection (e.g., every intermediate CDNX use this information to determine over what path(s) the bootstrap message may be forwarded).

Further, CDN 1 may attempt to discover CDNs for peering. It may send a DISCOVER_PEER message to its CDNX, as illustrated by message 3. CNDX 1 may then check Interconnection Policies it received from other CDNs, potentially through CDNXs, and may send a response to DISCOVER_PEER message 3 describing CDNs matching the discovery request, as shown by message 4.

In an alternative embodiment, a CDNX receiving an advertisement from another CDNX (i.e., message 1) may forward the advertisement to its CDNs, such as illustrated by message 2, and the CDNs may store their own CDN discovery entries. In such embodiments, there may be no need for explicit DISCOVER_PEER messages (i.e., message 3).

A possible transport mechanism for CDNI messages is JSON or XML encoding over a HTTP REST interface. In this case, using the example from FIG. 7, the exchange in one example embodiment may be as shown below. Note that responses that do not carry significant data (e.g., responses that carry only a status code) are omitted from the diagrams for clarity. Also, note that the various messages introduced herein may be similarly implemented using HTTP requests and responses.

CDN 2→CDNX2: HTTP POST to URL
http://rri.cdnx2.net/advertisement/cdn2.com. The request body includes the advertisement data encoded in JSON

CDNX 2→CDN2: HTTP 2000K

CDNX 2→CDNX1: HTTP POST to URL
http://rri.cdnx1.com/advertisement/cdnx2.net/cdn2.com

The request body includes the advertisement data encoded in JSON. The advertisement data may have been updated by CDNX 2.

CDNX 1→CDNX2: HTTP 2000K

CDN 1→CDNX1: HTTP POST to URL
http://rri.cdnx1.com/discovery/cdn1

The request body includes the discovery data encoded in JSON.

CDNX 1→CDN1: HTTP 200 OK

The request body includes the discovery response data encoded in JSON.

A CDN Multilateral INTERCONNECTION_POLICY_ADVERTISEMENT message may be used to provide a CDNX with information about services offered by a CDN having a multilateral agreement with that CDNX. This can be provisioned offline or provided and updated using CDNI. This CDN Multilateral INTERCONNECTION_POLICY_ADVERTISEMENT may have information elements describing the delivery service that this CDN is willing to provide to other CDNs in multilateral agreements with their own CDNX. It may include one or more of:
(i) CDN interconnection identifier (CDNI-ID) between a CDN and a CDNX, which can be built, for example, using both CDN and CDNX domain names, e.g., cdn-example.com.cdnx-example.net;
(ii) Geographical coverage for delivery (e.g., IP address blocks of covered end-users);
(iii) Supported delivery protocols;
(iv) Black list/white list of CDNs with which to interconnect;
(v) Supported Service Level Agreements (SLA) associated with (a reference to) a description of these levels of services (the CDN sender can use this entry to advertise its ability to deliver content following one or more SLAs, e.g., a CDN delivering to subscribers of a mobile network may advertise a level of service ensuring a minimum guaranteed downlink bit rate and a maximum packet loss);
(vi) costs associated with combinations of other service parameters also may be present (e.g., cost per megabyte of delivery for adaptive HTTP streaming using a given SLA [[??WHAT'S AN SLA??]] in a given country); costs may also vary depending on time or day and day of week;
(vii) Costs added by CDNXs may be appended as independent information elements or merged transparently with other costs.

The aforementioned new CDNI message, INTERCONNECTION_POLICY_ADVERTISEMENT, from CDN to CDNX, may be used to convey this information as part of the initial interconnection between CDN 2 and CDNX 2. This same message may be used to update this information later during the interconnection lifetime. Alternatively, these messages may be sent periodically.

CDN Peer Discovery may take multiple forms, including the following two exemplary alternate models. In a first alternative model, CDN advertisements reach and may be stored by all CDNXs and CDNs. Therefore, a CDN may collect and analyze all the advertisements to find a suitable peer. The CDN potentially may analyze a large amount of data about other CDNs that is irrelevant to that CDN. The CDN also has raw information and is not limited in how it may handle this information.

In a second model, the advertisements are not forwarded from the CDNXs to the CDNs, but only received and stored at the CDNXs, and explicit requests may be sent from a CDN to its directly interconnected CDNX. As opposed to the first alternative, this method may be easier to implement for the CDN operator. More specifically, a new CDNI message, for example named DISCOVER_PEER, may be created to enable discovery of peer CDNs. The content of this message may be based on the CDN service advertisement information described above, and may contain the same information elements. However, the DISCOVER_PEER message may alternatively or additionally contain logical operators to indicate mandatory or optional subsets; e.g., “served country should be either one of Canada, USA or Mexico”, or “cost of delivery should be lower than X”.

The response by the directly connected CDNX to the DISCOVER_PEER message may contain a list of CDNs available for dynamic interconnection, each CDN associated with its interconnection policy information. The interconnection policy information may be pre-processed by the CDNX before sending (e.g., service cost per CDNX may be merged into one bundled cost; e.g., CDN black list/white list may be filtered out).

Upon reception of the response, a CDN may select one or more CDNs with which it wishes to interconnect. The CDN may then proceed with CDNI interconnection.

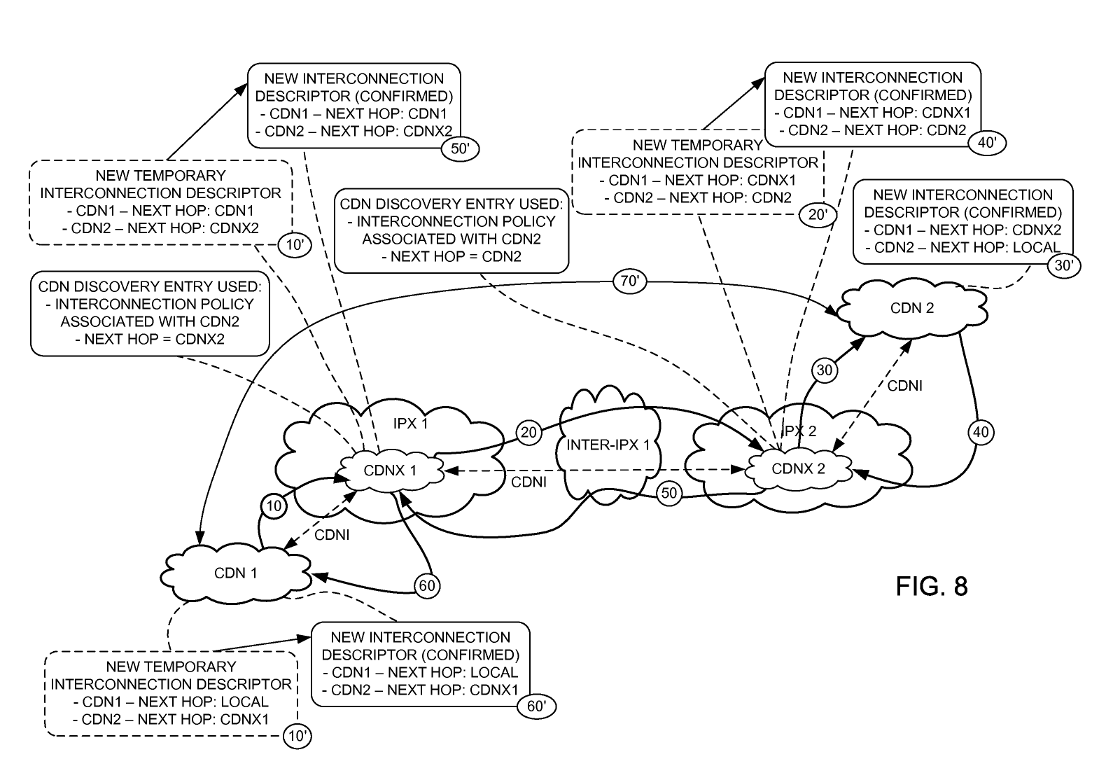

In a multilateral agreement, there may be CDNX Assisted Interconnection Bootstrap, an exemplary embodiment of which is shown in FIG. 8. (In FIG. 8. the message paths are shown by connecting lines labeled with reference numerals, e.g., message path 30, while information about the contents of those messages are shown in bubbles labeled with the corresponding message path reference number followed by a prime symbol, e.g., 30′). Once a peer CDN 2 is selected by an originating CDN 1, the originating CDN 1 may initiate an interconnection bootstrap procedure. This is done by sending a message (e.g., INTERCONNECT_BOOTSTRAP) to CDNX 1, as shown at 10 in FIG. 8. This message may be forwarded from CDNX to CDNX (as illustrated by message 20 between CDNX 1 and CDNX 2 in FIG. 8) until it finally reaches the CDNX that is directly interconnected with the target CDN. In this example, that would be CDNX 2 because the target CDN is CDN 2, which is served by CDNX 2. Then CDNX 2 forwards the message to target CDN 2, as illustrated by message 30 in FIG. 8) A CDNX may know which routes are available based on information obtained from a previously received message, such as INTERCONNECTION_POLICY_ADVERTISEMENT (e.g., as stored in a Discovery Entry). In case several routes are possible, a CDNX may choose the next hop based on cost, a commercial agreement, or one or more other criteria.

Alternatively, as discussed below, several paths may be selected, and the INTERCONNECTION BOOTSTRAP request may be sent over each of them.

The response (accepting or rejecting the interconnection offer) may follow the same path in the reverse direction, as illustrated by messages 40 (from CDN 2 to CDNX 2), 50 (from CDNX 2 to CDNX 1), and 60 (from CDNX 1 to CDN 1) in FIG. 8. Additional information may be exchanged using these messages, such as an identification of the CDN Interconnection gateways that will terminate the direct CDN 1-CDN 2 Interconnection and/or a shared secret that can be used to secure the direct CDN 1-CDN 2 Interconnection initiation.

To summarize the above, the INTERCONNECT_BOOTSTRAP message exchange may enable: negotiating the establishment of a direct CDN Interconnection between CDN 1 and CDN 2; an exchange of bootstrap information between CDN 1 and CDN 2 to facilitate this direct CDN interconnection; the recording of a fixed path through intermediate CDNXs (where the path may be embodied by Interconnection Descriptors present on every hop of the path); and the exchange of logs related to the interconnection between these 2 CDNs.

One or more of the following information elements may be present in a bootstrap message such as the INTERCONNECT_BOOTSTRAP message:
(i) Type (request or response);
(ii) Message source identifier and message destination identifier (both can be CDNI-IDs such as cdn-1.net.cdnx-1.com);
(iii) The recording of the full path, e.g., a list of all CDNXs on the path (his recording can be useful for information and debugging);
(iv) Additional bootstrap information (e.g., FQDN of CDNI Gateway that will terminate the CDN Interconnection on the message source side and/or security related information used to generate a shared secret using an algorithm such as Diffie-Hellman).

After this phase, one of the two CDNs may initiate the direct interconnection with the other CDN. This is shown by interconnection 70 in FIG. 8. For example this may use the procedure envisioned by the IETF CDNI Working Group, using the CDNI Control Interface. This direct interconnection does not necessarily cross the same networks as the inter-CDNX path used by the INTERCONNECT_BOOTSTRAP request and response messages. In one embodiment, the direct CDN 1-CDN 2 interconnection is initiated by CDN 2 upon reception of the bootstrap request. Once the interconnection setup is successful, CDN 2 may send the bootstrap response back to CDN 1 through CDNX 2.

Logs may be exchanged over the Inter-CDNX Interconnection. As described above, there is a path between Interconnected CDNs, coming through one, two, or more CDNXs. These CDNXs may internally maintain information about the interconnection. CDNs also may maintain interconnection descriptors to facilitate log distribution.

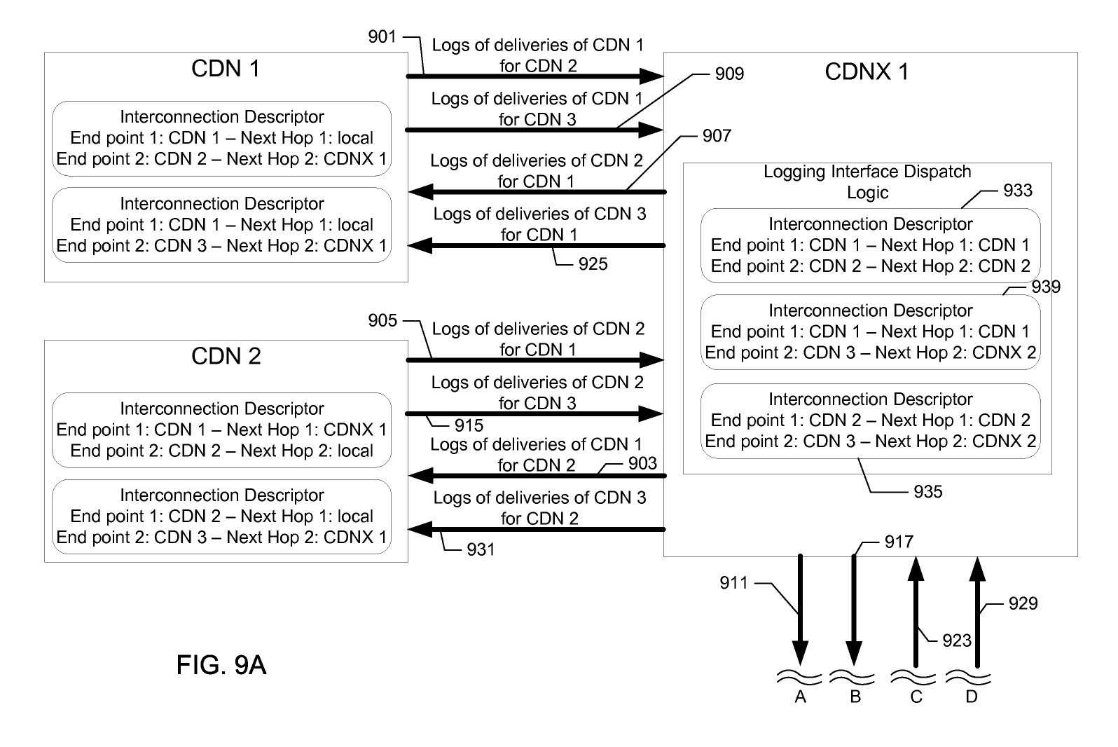

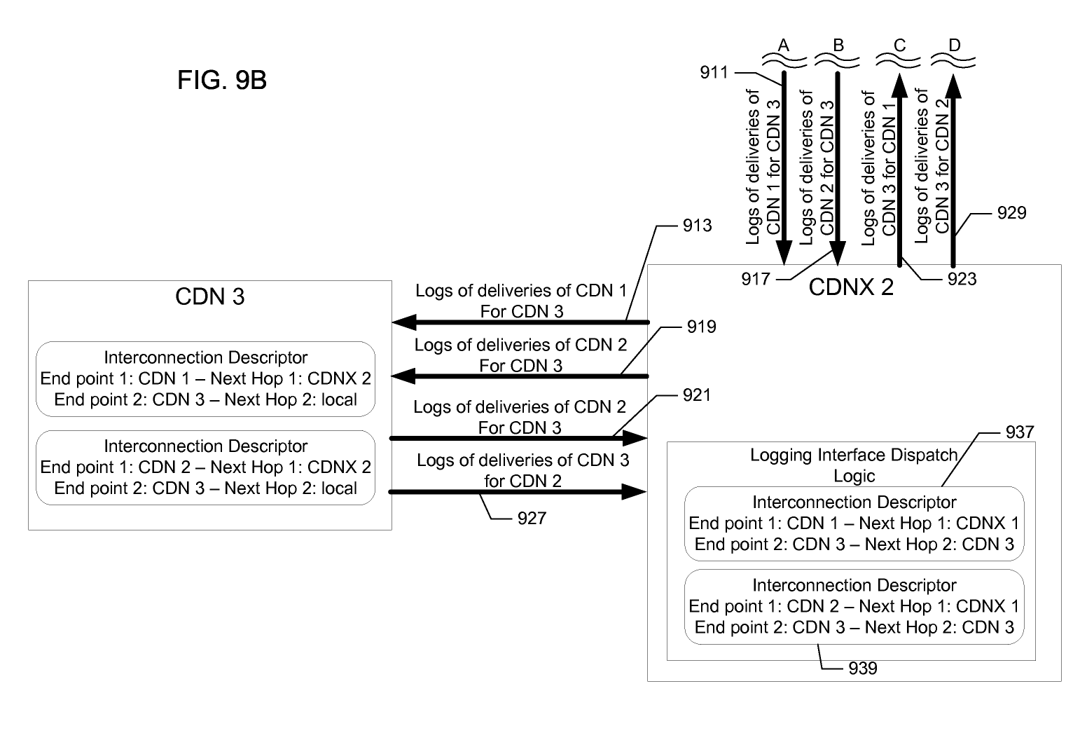

FIGS. 9A and 9B collectively show examples of log forwarding over the CDNI logging interface. In the example illustrated by FIGS. 9A and 9B, there are three CDNS and two CDNXs. Specifically, CDN 1 and CDN 2 are directly connected to the same CDNX, namely, CDNX 1. CDN 3 is directly connected to another CDNX, namely, CDNX 2. FIGS. 9A and 9B show the interconnections that exist between these three exemplary CDNs, namely, CDN 1-CDN 2, CDN 1-CDN 3, CDN 2-CDN 3. Specifically, logs of deliveries of CDN 1 for CDN 2 follow the path 901 (from CDN 1 to CDNX 1) to path 903 (from CDNX 1 to CDN 2). Logs of deliveries of CDN 2 for CDN 1 follow the path 905 (from CDN 2 to CDNX 1) to path 907 (from CDNX 1 to CDN 1). Logs of deliveries of CDN 1 for CDN 3 follow the path 909 (from CDN 1 to CDNX 1) to path 911 (from CDNX 1 to CDNX 2) to path 913 (from CDNX 2 to CDN 3). Logs of deliveries of CDN 2 for CDN 3 follow the path 915 (from CDN 2 to CDNX 1) to path 917 (from CDNX 1 to CDNX 2) to path 919 (from CDNX 2 to CDN 3). Logs of deliveries of CDN 3 for CDN 1 follow the path 921 (from CDN 3 to CDNX 2) to path 923 (from CDNX 2 to CDNX 1) to path 925 (from CDNX 1 to CDN 1). Finally, logs of deliveries of CDN 3 for CDN 2 follow the path 927 (from CDN 3 to CDNX 2) to path 929 (from CDNX 2 to CDNX 1) to path 931 (from CDNX 1 to CDN 2).

The CDNXs may maintain interconnection descriptors containing identifiers of the end points and next hops in each direction, such as interconnection descriptor 933, 934, and 935 stored in CDNX 1 and interconnection descriptors 937 and 939 stored in CDNX 2. Descriptor 933 stored in CDNX 1 describes the path between CDN 1 and CDN 2. Descriptor 934 stored in CDNX 1 describes the path between CDN 1 and CDN 3. Descriptor 935 stored in CDNX 1 describes the path between CDN 2 and CDN 3. Descriptor 937 stored in CDNX 2 describes the path between CDN 1 and CDN 3. Finally, descriptor 939 stored in CDNX 2 describes the path between CDN 2 and CDN 3. Using this information, a CDNX knows it can expect logs from CDN 1 related to deliveries on behalf of CDN 3 from one side, and logs from CDN 3 related to deliveries on behalf of CDN 1 from the other side. The CDNX also knows where to forward these logs. Cascading payments may occur between directly interconnected entities, e.g., CDN 1 compensates CDNX 1 to account for deliveries made by CDN 3. CDNX 1 compensates CDNX 2 for these same deliveries (minus what is obtained from CDN 1 to account for the services of CDNX 1). Finally, CDNX 2 can compensate CDN 3.

An interconnection descriptor may contain one or more of the following information elements:
(i) CDNI-ID of CDN 1 interconnection point (e.g., cdn-1.com.cdnx-1.net);
(ii) Next hop CDNX towards this CDN;
(iii) CDNI-ID of CDN 2 interconnection point;
(iv) Next hop CDNX towards this CDN.

In the methods described above, the inter-CDNX path between CDN 1 and CDN 2 is set up at bootstrap time, and then stays static. Alternately, dynamic paths may be used for exchanging logs over Inter-CDNX Interconnections. In one such alternate embodiment, multiple inter-CDNX paths may be set up at bootstrap time. Which path is actually selected for use for a log entry may depend on CDNX policy. Additionally, inter-CDNX paths may also be updated dynamically.

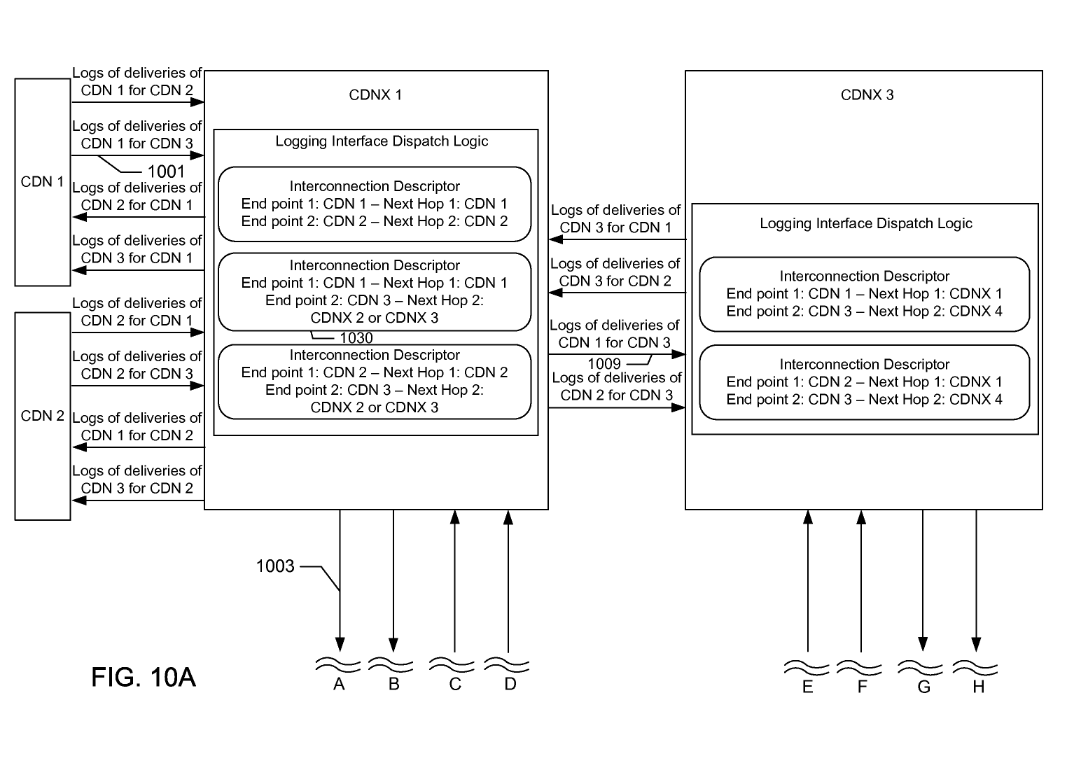

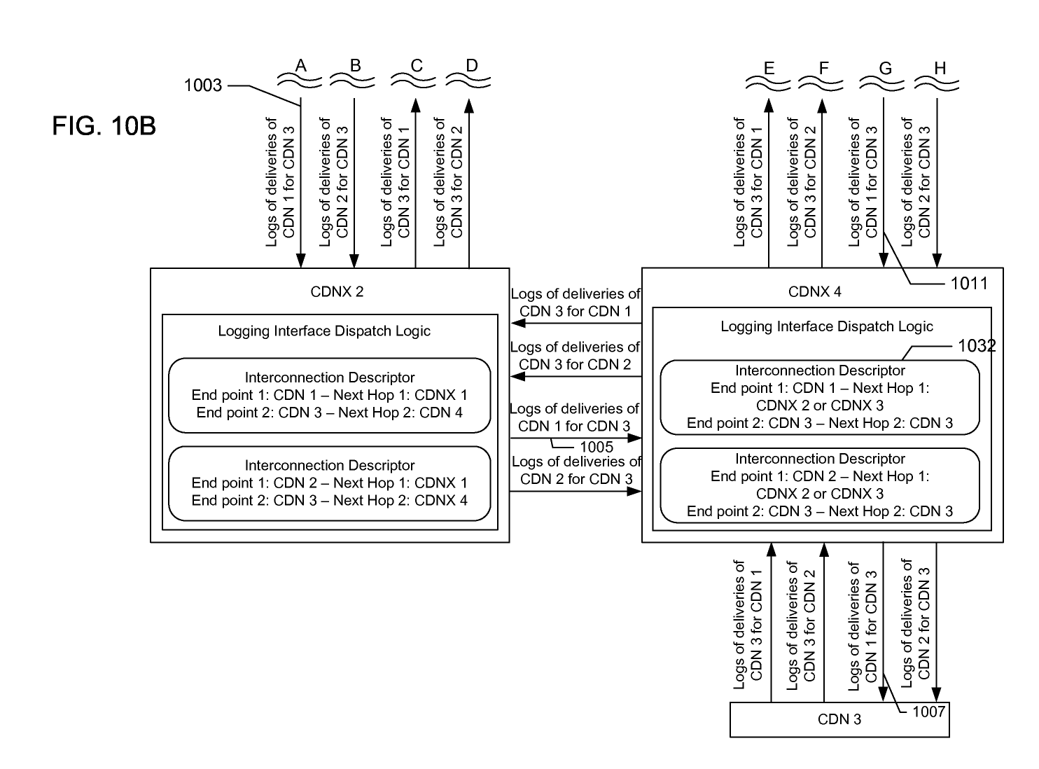

As shown in FIGS. 10A and 10B, multiple inter-CDNX paths may be used. Interconnections exist between CDN 1-CDN 2, CDN 1-CDN 3 and CDN 2-CDN 3. Only the exemplary path components between CDN 1 and CDN 3 are labeled in the FIGS. and discussed herein in order not to obfuscate the disclosure. Thus, focusing on the CDN 1-CDN 3 interconnection as an exemplary case, CDNX 1 may choose CDNX 2 or CDNX 3 as the next hop. During interconnection bootstrap, CDNX 1 can send the CDN Interconnection message (not shown) through every available path. Then CDNX 2 and CDNX 3 may then forward the bootstrap request to CDNX 4. CDNX 4 may forward one bootstrap request to CDN 3. CDN 3, for example, accepts the requests and may send a response through CDNX 4. The response message may be sent by CDNX 4 over both CDNX 3 and CDNX 2. In these cases, more than one “next hop” entry is created in the interconnection descriptor. In this example, CDNX 1 and CDNX 4 may selectively forward a particular log entry. Note that the two paths between CDN 1 and CDN 3 are (a) 1001 (CDN 1 to CDNX 1) to 1003 (CDNX 1 to CDNX 2) to 1005 (CDNX 2 to CDNX 4) to 1007 (CDNX 4 to CDN 3) and (b) 1001 (CDN 1 to CDNX 1) to 1009 (CDNX 1 to CDNX 3 to 1009 (CDNX 3 to CDNX 4) to 1007 (CDNX 4 to CDN 3). Note also interconnection descriptor 1030 stored in CDNX 1 and interconnection descriptor 1032 stored in CDNX 4, both of which describe two potential paths (either through CDNX 2 or through CDNX 3). The actual selection may be based on time of day, current cost, dynamic load information, etc.

In yet another such dynamic path embodiment, inter-CDNX paths are additionally updated during the life of the CDN Interconnection. For example, if CDNX 1 becomes interconnected directly with CDNX 4, then it may wish to stop using either of the paths through CDNX 2 or CDNX 3 from that time forward. One method to perform this dynamic update is for a CDNX to re-send a bootstrap message related to an existing connection. This may be triggered by a particular event, e.g., new CDNX-CDNX interconnection event or a new advertisement received from another path.

CDN-CDNX Interconnection Initiation may use a Pull method or a Push method. For example, a first CDN, e.g., CDN 1, may provide an API that any CDNX may use to provide its service. In one Pull type embodiment, a CDNX, e.g., CDNX 1, initiates the CDN-CDNX interconnection and requests an advertisement from the CDN, e.g., CDN 1, and stores the advertisement information in a Discovery Entry. Then, CDNX 1 may bring business to CDN 1 when another CDN, e.g., CDN 2, discovers it through CDNX 1. For example, if CDNX 1 receives a DISCOVER_PEER message from CDN 2 and finds a Discovery Entry corresponding to CDN 1 that meets the policy requirements set forth therein, CDNX 1 may return an INTERCONNECTION_POLICY_ADVERTISEMENT to CDN2 for CDN 1. In one embodiment, CDN 2 may then initiate a bootstrap procedure by sending an INTERCONNECT_BOOTSTRAP message to CDN 1 through an inter-CDNX pathway (such as previously described) to bootstrap the new CDN 1-CDN 2 direct interconnection. In an alternate embodiment, CDN 1 may initiate the bootstrap process. For instance, when CDNX 1 finds a compatible Discovery entry responsive to a DISCOVER_PEER message from CDN 2, it sends a corresponding DISCOVER_PEER message to CDN 1. In order to conserve messaging overhead, CDN 1 may respond to the DISCOVER_PEER message from CDNX 1 directly with an INTERCONNECT_BOOTSTRAP message addressed to CDN 2.

In such embodiments, CDN 2 may receive INTERCONNECT_BOOTSTRAP messages from multiple CDNs that meet its policy requirements, Hence, one in such cases, CDN 2 may execute a selection policy to choose one.

In “pull” type embodiments, advertisements may be provided outside of a CDN-CDNX interconnection scope. For example, advertisements may be provided through a web service, and a CDNX will initiate the CDN-CDNX interconnection only when it has a suitable candidate wishing to interconnect with this CDN. In such scenarios, the INTERCONNECT_POLICY_ADVERTISEMENT and DISCOVER_PEER messages may not be used at all, and only the INTERCONNECT_BOOTSTRAP messages are used,

A “Pull” method is well suited to a scenario where CDNXs are not well interconnected with each other. In this scenario, instead of building a global content network, multiple smaller federations may be formed. Then a CDN may “listen” to CDNXs. When a federation needs additional coverage or capability, its CDNX operator may interconnect with a suitable CDN that is listening for new interconnections from CDNXs.

In contrast with this, the exemplary “Push” method described previously is well suited to scenarios where all CDNXs are interconnected in a mesh fashion, such as discussed above in connection with FIG. 5. In that scenario, a CDN may select a CDNX that is interconnected to the global mesh network. Then the CDN may be either passively waiting for interconnections or actively seeking interconnections or both (while “pull” is only supporting a passive approach).

The level of automation may vary among the embodiments described herein. In various procedures and embodiments described herein, CDNs and CDNXs are initiating, forwarding, or terminating signaling messages for advertisement, peer discovery, interconnection bootstrap, logging, and CDN Interconnection. Inside CDNs and CDNXs, associated decisions to initiate/accept/forward may be mediated by a human operator, or may be automated.

For example, a CDN operator may define the content of the advertisement sent by a CDN to a particular CDNX. If a CDN interconnects with several CDNXs, the advertisement may be the same or may be different (e.g., different costs may be proposed). On the other side, the CDN operator may also define automatic policies to determine the content of the advertisement to CDNXs.

Similarly, CDNXs may filter CDN advertisements and decide to update them with different costs before forwarding them to CDNX peers. CDNXs may also decide not to forward a particular advertisement toward some of its peers. Again, this behavior may be automated through the use of policies.

A CDN peer discovery may be initiated by a human operator, for example, in relation with a business decision to lower cost or improve delivery quality in a geographical area. Alternatively this decision may result from an automated process, for example, a periodic check for better deals.

Interconnection bootstrap may be initiated by a CDN following a business decision to partner with a remote CDN peer based on advertisement from this peer. Alternatively, this may also be automatic based on cost and service information from the advertisement. A CDNXs decision to forward bootstrap messages should typically be automatic, based on a discovery entries next hop information.

Logs exchange may occur at a higher rate than the other signaling described above. When several CDNX-CDNX paths are available, a CDNX may select the next hop based on local policy, for example lower cost or load balancing.

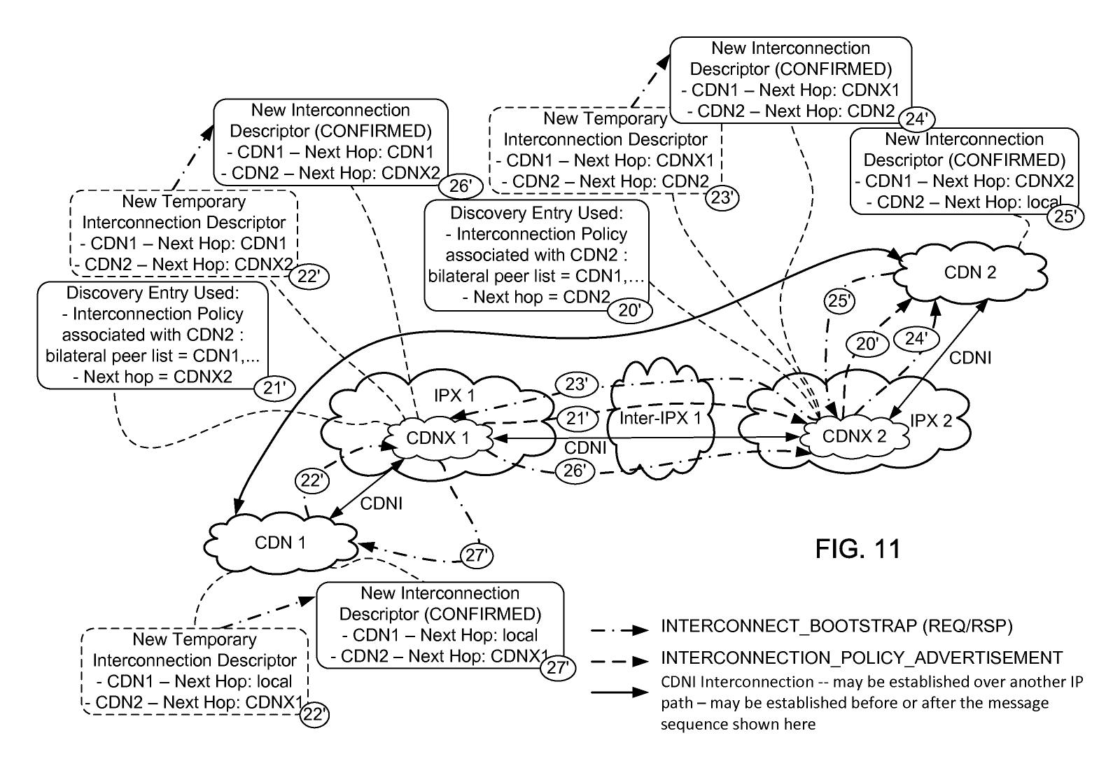

In a further embodiment, CDNX support for bilateral agreements may be provided. In this scenario, CDN 1 may have an interconnection with CDNX 1. FIG. 11 is a diagram illustrating an exemplary scenario for this situation. The operators of CDN 1 and CDN 2 may have a business agreement, and may set up a direct interconnection between their CDNs using CDNI. However, what is additionally desired is a proper path for logs to transit through one or more CDNXs between CDN 1 and CDN 2. CDN 1 and CDN 2 enter in a bilateral agreement for CDN interconnection. They may set up a direct interconnection using, e.g., CDNI. For settlement, the two CDNs may choose to pass through one or more CDNX because this enables unified consolidated billing and simplifies logging inside their own network.

CDN 1 and CDN 2 may be interconnected with the same CDNX or, in the more general case, may be interconnected with different CDNXs, e.g., CDNX 1 and CDNX 2 interconnected directly to each other or through other intermediate CDNXs.

Bilateral CNDI session establishment will be described with reference to FIG. 11. In one embodiment, CDN 1 and CDN 2 exchange INTERCONNECT_BOOTSTRAP messages to enable the creation of the inter-CDNX path. This is illustrated by the following messages (which are similar to the INTERCONNECT_BOOTSTRAP messages described in connection with FIG. 8 except as otherwise noted herein); message 22 from CDN 1 to its CDNX 1, message 23 from CDNX 1 to CDNX 2, message 24 from CDNX 2 to CDN 2, message 25 from CDN 2 to its CDNX 2, message 26 from CDNX 2 to CDNX 1, and message 27 from CDNX 1 to CDN 1. Also, similarly to the description in connection with FIG. 8, bubbles showing the interconnection descriptors created and stored at the various nodes responsive to the information in the INTERCONNECT_BOOTSTRAP messages are labeled with the same reference numeral as the message to which it corresponds followed by the prime symbol. ′.

If neither CDN 1 nor CDN 2 has a multilateral agreement, there may have been no prior multilateral agreement advertisements. Therefore, to ensure that the CDNXs have enough information to properly forward INTERCONNECT_BOOTSTRAP and to properly set up the CDNX settlement chain, CDN 1, CDN 2, or both should send an advertisement (INTERCONNECTION_POLICY_ADVERTISEMENT) through the CDNX federation similarly to the process described in connection with FIG. 7. Particularly, prior to propagation of the INTERCONNET BOOTSTRAP messages, CDN 1 and CDN 2 may send INTERCONNECTION_POLICY_ADVERTISEMENT messages, to their respective CDNXs. This is illustrated in FIG. 11 only for CDN 2 by message 20 (from CDN 2 to CDNX 2) and message 21 (forwarding the interconnection policy information of CDN 2 from CDNX 2 to CDNX 1 (and possibly adding CNDX 2's own cost information). As in other embodiments described hereinabove, the intermediate CDNX(s) may use this advertisement to create a discovery entry(ies), which may later be used to properly forward bootstrap messages. Bubbles 20′ and 21′ illustrate the discovery entries that may be created and stored at CDNX 2 and CDNX 1, respectively. Intermediate CDNXs may update the advertisements with information such as service cost. Furthermore, multiple paths may be established as described above. The advertisement messages 20 and 21 only need to list the CDN peer for bilateral agreements. For example, in this diagram, CDN 2 may send an advertisement including CDN 1 as bilateral peer (see the contents of the discovery entries 20′ and 21′). This advertisement may not enable any multilateral peer discovery unless CDN 2 additionally advertises as part of a multilateral agreement. If so, a single INTERCONNECTION_POLICY_ADVERTISEMENT may merge multilateral and bilateral information.

INTERCONNECTION_POLICY_ADVERTISEMENT messages for the bilateral case may hold the following information:
(i) CDNI-ID of the CDN interconnection with this CDNX, e.g., cdn-example.com.cdnx-example.net.
(ii) List of bilateral CDN peers; these can be CDNI-IDs (e.g., cdn-a.com.cdnx-1-example.net) or domain names (cdnx-1-example.net).

In one embodiment, illustrated in FIG. 12, the UE 1207 of an end user may have a preferred CDN 1203. In one example, this can be a CDN operated by an ISP with which the end user has an agreement to use this CDN as a preferred CDN.

When requesting content, the UE 1207 may include a reference to the preferred CDN 1203 in the request. For example, this information can be communicated as part of the URL or as an HTTP header (e.g. cdn-id: example-cdn.com). Alternately, this information may be provided as part of a DNS query (e.g., a new information element providing cdn-id as a hint) or through other means before the content request or during the content request. Upon reception of this information, the upstream CDN 1205 may use it to select the preferred CDN 1203 as the downstream CDN. If the CDNs are not yet interconnected via the CDNX network 1201, the interconnection can be bootstrapped as described in earlier embodiments. Alternately, an existing CDN interconnection or a chain of existing CDN interconnections ending with the preferred CDN may be used.

The preferred CDN may incentivize the upstream CDN 1205 to use the preferred CDN 1203 for the delivery by offering to perform the delivery at no cost or a reduced cost. Using CDNI, the upstream CDN 1205 obtains logs of the delivery and can therefore account for this delivery to the publisher. All or a portion of the savings achieved by using the lower cost preferred CDN may be passed on to the publisher of the content, for example.

The preferred CDN 1203 may deliver the content as part of an agreement with the end user (e.g., QoS guaranteed delivery by the ISP's CDN).

In summary, the steps of one exemplary process in accordance with this embodiment include the UE 1207 requests content from the upstream CDN 1205 and provides its preferred CDN ID within the request or prior to the request (as reflected at 1211 in the FIG.). If the upstream CDN 1205 does not currently have an interconnection with the preferred CDN 1203, then the upstream CDN 1205 discovers the preferred CDN through one or more CDNXs 1201, if needed, as described previously hereinabove, and then bootstraps an inter-CDN connection with this preferred CDN, as reflected at 1212 in the FIG. At 1213, a CDNI interconnection is established, also as previously described herein. If the upstream CDN 1205 already has an interconnection with the preferred CDN 1203, then steps 1212 and 1213 are not performed.

Finally, the requested content is delivered to the UE 1207 from the upstream CDN 1205 through the preferred CDN 1203 (e.g., the upstream CDN 1205 sends a message to the UE 1207 redirecting the UE to expect to receive the requested content from the preferred CDN 1203). Upon receipt of such message from the upstream CDN, the UE 1207 reconfigures the session to communicate with the preferred CDN 1203, rather than the upstream CDN 1205. Then, when receiving the request from the UE 1207, the preferred CDN 1203 acquires the content from the upstream CDN 1205 and delivers it to the UE.

One of the advantages of such a system over a system in which the UE 1207 simply requests an entity (e.g., its ISP) to fetch the original content and obtaining the content from this entity is that the entity/ISP would be acting as a normal end user in such a scenario and not as a downstream CDN. Hence, the upstream CDN would not know the identity of the ultimate recipient of the content, and would not receive logs for the delivery. Therefore, the upstream CDN would not know if the delivery was successful or the QoS of the interconnection. Further, other CDNI features available through the systems and technologies disclosed herein, such as access control, would not be available for use. When coupled with the features of the earlier embodiments, another advantage of this embodiment is that the interconnection can be bootstrapped on-demand and possibly dropped after use.

### CONCLUSION

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system described above are possible without departing from the scope of the invention. In view of the wide variety of embodiments that can be applied, it should be understood that the illustrated embodiments are exemplary only, and should not be taken as limiting the scope of the following claims.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, 116, and any claim without the word “means” is not so intended.

### EMBODIMENTS

In one embodiment, a method is implemented of advertising conditions for peering with a first content delivery network (CDN 1) including at least one parameter selected from a group consisting of a capabilities parameter, a footprint parameter, and a cost parameter, via a first CDN Exchange (CDNX 1); receiving data from peer CDNs via CDNX 1; initiating a bootstrap procedure via CDNX 1; and initiating a direct interconnection with a second CDN (CDN 2).

In accordance with this embodiment, the method may further comprise: exchanging logs between CDN 1 and CDN 2 through CDNXs.

One or more of the preceding embodiments may further comprise, wherein cascading payments are provided through CDNXs.

One or more of the preceding embodiments may further comprise, wherein dynamic paths are used to transmit logs through the CDNX inter-network.

One or more of the preceding embodiments may further comprise, wherein either a pull model or a push model is used for CDN-CDNX interconnection.

One or more of the preceding embodiments may further comprise, wherein CDNI logging messages are passed through intermediate nodes and a subset of CDNI signaling is not passed through intermediate nodes.

Another embodiment comprises a method of cascading payment via CDNXs for interconnected CDNs.

Another embodiment comprises a method of interconnecting several CDN Exchanges together.

One or more of the preceding embodiments may further comprise, wherein there are dynamic interconnections between CDNs that are not connected to the same CDN exchange.

One or more of the preceding embodiments may further comprise, wherein the CDNs are interconnect using either a bilateral or multilateral model.

Another embodiment comprises a method of interconnecting CDN Exchanges into a CDN federations.

One or more of the preceding embodiments may further comprise, wherein the federation is managed dynamically.

One or more of the preceding embodiments may further comprise, wherein the federation utilizes an exchange of logs through the interconnected CDN Exchanges for settlement.

One or more of the preceding embodiments may further comprise, wherein CDNI signaling (such as, e.g., request routing) is directly exchanged between the CDNs.

In another embodiment or in connection with one or more of the preceding described embodiments, a method comprises interconnecting CDN Exchange (CDNXs) based on CDN Interconnection (e.g., Logging Interface, Control and Request Routing Interface).

One or more of the preceding embodiments may further comprise, wherein a CDNI Request Routing Interface performs CDN Peer Discovery based on policy advertisements.

One or more of the preceding embodiments may further comprise, wherein two message types are used including an interconnection policy advertisement message and a peer discovery message.

One or more of the preceding embodiments may further comprise, wherein a CDNI Request Routing and Control Interface performs CDN Interconnection Bootstrap.

One or more of the preceding embodiments may further comprise, wherein two message types are used including an interconnection policy advertisement message and a bootstrap interconnect message.

In another embodiment or in connection with one or more of the preceding described embodiments, a method comprises managing a CDN Exchanges (CDNX) comprising forwarding of logs to CDNs not directly interconnected with the CDNX.

One or more of the preceding embodiments may further comprise, wherein the CDNX maintains a bilateral and multilateral discovery entry table based on advertisements, and uses the table for peer discovery and for making forwarding decisions for bootstrap messages.

One or more of the preceding embodiments may further comprise maintaining interconnection descriptors based on advertisements and bootstrap messages, and using the descriptors for forwarding of logs.

In another embodiment or in connection with one or more of the preceding described embodiments, a method comprises using peer discovery and interconnection bootstrap to interconnect CDNs that are interconnected with different CDNXs.

In another embodiment or in connection with one or more of the preceding described embodiments, a system comprises: CDN-CDNX interconnections configured for CDNs to send and receive CDNI logs, advertisement, discovery, and/or bootstrap of a CDN-CDN interconnection; CDNX-CDNX interconnections configured to forward logs, advertisement, discovery, and/or bootstrap; and CDN-CDN interconnections configured for CDN Interconnection including control, request routing and/or metadata.

In another embodiment or in connection with one or more of the preceding described embodiments, a method of CDNX assisted peer discovery comprises: advertising an Interconnection Policy by sending a policy advertising message from a CDN to a CDNX; and receiving a response message from the CDNX.

In another embodiment or in connection with one or more of the preceding described embodiments, a method of CDNX assisted peer discovery comprises: receiving a policy advertising message from a CDN; generating a CDN Discovery Entry in a table; and transmitting at least some data associated with the policy advertising message or the CDN discovery entry to a second CDNXs.

One or more of the preceding embodiments may further comprise, wherein the CDNX includes its service cost in the at least some data.

One or more of the preceding embodiments may further comprise using the discovery entry table to generate peer discovery response messages and/or to determine where to forward interconnect bootstrap messages.

One or more of the preceding embodiments may further comprise: receiving a peer discovery request message; checking Interconnection Policies received from other CDNs; and generating a response message identifying CDNs matching the peer discovery request message.

In another embodiment or in connection with one or more of the preceding described embodiments, a method comprises generating a CDN multilateral interconnection policy advertisement message having information elements describing the delivery service that the CDN is configured to provide to other CDNs.

One or more of the preceding embodiments may further comprise, wherein the information elements include one or more of any one, or any combination of, the following parameters:

CDN interconnection identifier;

Geographical coverage identifier;

Supported delivery protocols identifier;

Black list/White list of CDNs with which to interconnect;

Supported level of services;

Costs information.

In another embodiment or in connection with one or more of the preceding described embodiments, a CDN peer discovery method comprises sending CDN advertisements to each CDNX and CDN in a CDN federation.

One or more of the preceding embodiments may further comprise, wherein a CDN collects and analyzes all advertisements to find a suitable peer.

In another embodiment or in connection with one or more of the preceding described embodiments, a CDN peer discovery method comprises sending explicit CDN advertisements and/or requests from the CDN to its directly interconnected CDNX.

In another embodiment or in connection with one or more of the preceding described embodiments, a method of CDNX Assisted Interconnection Bootstrap comprises: selecting a peer CDN; initiating an interconnection bootstrap procedure by sending a message to a CDN Exchange (CDNX) for forwarding to a remote CDNX that serves the selected peer CDN.

One or more of the preceding embodiments may further comprise, wherein a bootstrap message exchange is used to negotiate the establishment of a direct CDN Interconnection between a first CDN (CDN 1) and a second CDN (CDN 2).

One or more of the preceding embodiments may further comprise, wherein a bootstrap message exchange is used to exchange bootstrap information between CDN 1 and CDN 2 and to facilitate a direct CDN interconnection.

One or more of the preceding embodiments may further comprise, wherein a bootstrap message exchange is used to record a fixed path through intermediate CDNXs.

One or more of the preceding embodiments may further comprise, wherein the path is characterized using Interconnection Descriptors present on every hop of the path and/or logs related to the interconnection between the two CDNs will be forwarded along the path.

One or more of the preceding embodiments may further comprise, wherein the interconnection descriptor may contain one or more of any one or any combination of the following information elements:

CDNI-ID of CDN 1 interconnection point;

Next hop CDNX towards this CDN;

CDNI-ID of CDN 2 interconnection point;

Next hop CDNX towards this CDN;

One or more of the preceding embodiments may further comprise, wherein one or more of any one, or any combination of, the following parameters are included in a bootstrap message:

Type (request or response);

Message source identifier and message destination identifier;

Path information;

Additional bootstrap information.

One or more of the preceding embodiments may further comprise, wherein an interconnection policy advertising message is generating included any one or more of the following information elements: (i) CDNI-ID of the CDN interconnection with this CDNX and (ii) list of bilateral CDN peers.

In another embodiment or in connection with one or more of the preceding described embodiments, a method for a Content Data Network (CDN) interconnected with a first Content Data Network Exchange (CDNX) to interconnect with other CDNs interconnected with the first CDNX of other CDNXs comprises: sending a first message to a first CDNX to which the CDN is interconnected, the first message comprising an advertisement of policies of the CDN for peering with other CDNs; conducting a bootstrap procedure for initiating an interconnecting with another CDN via the first CDNX; and

initiating a direct interconnection with the other CDN based on the bootstrap procedure.

One or more of the preceding embodiments may further comprise: sending a second message to the first CDNX comprising a discovery request seeking other CDNs that meet the CDNs interconnection policies for peering with other CDNs.

One or more of the preceding embodiments may further comprise: receiving a third message, responsive to the second message, from the first CDNX comprising a discovery request response comprising an identity of at least one other CDN that meets the policies for peering with the CDN.

One or more of the preceding embodiments may further comprise, wherein the discovery request response further comprises cost information for the services of CDNXs in a path between the CDN and the at least one other CDN.

One or more of the preceding embodiments may further comprise: selecting at least one other CDN identified in the discovery request response; and commencing a CDNI interconnection with the selected at least one other CDN.

One or more of the preceding embodiments may further comprise, wherein the bootstrap procedure comprises; sending an interconnect bootstrap message to the other CDN via the first CDNX indicating a desire to interconnect; and receiving from the other CDN via the first CDNX a response to the interconnect bootstrap message.

One or more of the preceding embodiments may further comprise, wherein the CDN and the other CDN further exchange additional information via at least the first CDNX.

One or more of the preceding embodiments may further comprise, wherein the further information exchanged between the CDN and the other CDN comprises at least one of (a) an identification of CDN Interconnection gateways that will terminate a direct interconnection between the CDN and the other CDN and (b) a shared secret that can be used to secure the direct interconnection between the CDN and the other CDN.

One or more of the preceding embodiments may further comprise, wherein the interconnection bootstrap message comprises at least one of the following information elements: (a) type; (b) message source identifier and message destination identifier; and (c) the full path between the CDN and the other CDN.

One or more of the preceding embodiments may further comprise, wherein the interconnect bootstrap messages are transmitted over a CDNI Control Interface.

One or more of the preceding embodiments may further comprise, wherein the first and second messages comprise CDN Interface (CDNI) messages.

One or more of the preceding embodiments may further comprise, wherein the first and second messages are transmitted over CDNI Request Routing Interfaces.

One or more of the preceding embodiments may further comprise, wherein the CDNI messages are transported using JSON.

One or more of the preceding embodiments may further comprise, wherein the CDNI messages are transported using XML over an HTTP REST interface.

One or more of the preceding embodiments may further comprise, wherein the policies for peering include at least one of capabilities, footprint, and costs.

One or more of the preceding embodiments may further comprise: receiving from the first CDNX a fourth message comprising an advertisement of policies of another CDN for peering with other CDNs; and storing a discovery entry corresponding to the fourth message.

One or more of the preceding embodiments may further comprise: sending a CDN multilateral interconnection advertisement message to the first CDNX comprising information about services offered by the CDN.

One or more of the preceding embodiments may further comprise, wherein the CDN multilateral interconnection advertisement message comprises information elements describing delivery services the CDN is willing to provide to other CDNs in multilateral agreements with the first CDNX.

One or more of the preceding embodiments may further comprise, wherein the CDN multilateral interconnection advertisement message comprises at least one of: (a) a CDN interconnection identifier (CDNI-ID) between the CDN and the first CDNX; (b) geographical coverage; (c) supported delivery protocols; (d) black list/white list of CDNs with which to interconnect; (e) supported level of services associated with a description of these levels of services; (f) costs associated with combinations of service parameters; and (g) costs added by CDNXs.

One or more of the preceding embodiments may further comprise: after initiating the direct interconnection with the other CDN, exchanging logs with the other CDN via the first CDNX.

One or more of the preceding embodiments may further comprise, wherein the direct connection between the CDN and the other CDN is based on a bilateral agreement between the CDN and the other CDN.

One or more of the preceding embodiments may further comprise, wherein the direct connection between the CDN and the other CDN is based on a multilateral agreement between the first CDNX and a CDNX with which the other CDN is interconnected.

In another embodiment or in connection with one or more of the preceding described embodiments, a method for a Content Data Network (CDN) interconnected with a first Content Data Network Exchange (CDNX) to interconnect with other CDNs interconnected with the first CDNX or other CDNXs, comprising: receiving a first message from a first CDNX requesting an advertisement of policies of the CDN for peering with other CDNs; receiving from the first CDNX a request from another CDN to interconnect with the first CDN; responsive to the request, conducting a bootstrap procedure with the other CDN via the first CDNX for initiating an interconnecting with the other CDN; and establishing a direct interconnection with the other CDN based on information gathered in the bootstrap procedure.

One or more of the preceding embodiments may further comprise, wherein the request further comprises cost information for the services of CDNXs in a path between the CDN and the at least one other CDN.

One or more of the preceding embodiments may further comprise, wherein the first messages and the request comprise CDN Interface (CDNI) messages.

One or more of the preceding embodiments may further comprise, wherein the CDNI messages are transported using JSON.

One or more of the preceding embodiments may further comprise, wherein the CDNI messages are transported using XML over an HTTP REST interface.

One or more of the preceding embodiments may further comprise, wherein the policies for peering include at least one of capabilities, footprint, and costs.

One or more of the preceding embodiments may further comprise: after initiating the direct interconnection with the other CDN, exchanging logs with the other CDN via the first CDNX.

In another embodiment or in connection with one or more of the preceding described embodiments, a method for a Content Data Network Exchange (CDNX) to facilitate interconnections between Content Data Networks (CDNs) via a plurality of interconnected CDNXs comprises: receiving from a first CDN an interconnection policy advertisement message disclosing policies for peering with the first CDN; storing a discovery entry disclosing the policies for peering with the first CDN in association with an identity of the first CDN; and transmitting an interconnection policy advertisement message to at least one other CDNX to which it is interconnected advertising the peering policies of the first CDN.

One or more of the preceding embodiments may further comprise: receiving other interconnection policy advertisement messages from other CDNXs containing policies for peering with CDNs interconnected with the other CDNXs.

One or more of the preceding embodiments may further comprise: storing discovery entries corresponding to the interconnection policy advertisements received from other CDNXs.

One or more of the preceding embodiments may further comprise: associating with each discovery entry next hop information disclosing the identity of a next CDN or CDNX in a path toward the CDN to which the discovery entry corresponds.

One or more of the preceding embodiments may further comprise; including in the interconnection policy advertisement message that is sent to at least one other CDNX additional information.

One or more of the preceding embodiments may further comprise, wherein the additional information comprises cost information for the services of the CDNX.

One or more of the preceding embodiments may further comprise: receiving from the first CDN a discovery request message seeking the identity of other CDNs that meet the first CDN's interconnection policies for peering with other CDNs; checking the discovery entries to determine if any meet the first CDN's interconnection policies; and sending a response message to the first CDN 1 comprising the identity of any other CDNs meeting the policies of the first CDN.

One or more of the preceding embodiments may further comprise, wherein the interconnection policy messages, discovery request messages, and response messages comprise CDN Interface (CDNI) messages.

One or more of the preceding embodiments may further comprise, wherein the CDNI messages are transported using JSON.

One or more of the preceding embodiments may further comprise, wherein the CDNI messages are transported using XML over an HTTP REST interface.

One or more of the preceding embodiments may further comprise; creating and storing path descriptors for paths between CDNs based on the interconnection policy advertisement messages received by the CDNX.

One or more of the preceding embodiments may further comprise: receiving an interconnect bootstrap message from the first CDN identifying another CDN with which the first CDN desires to interconnect; and forwarding the interconnect bootstrap message toward the other CDN.

One or more of the preceding embodiments may further comprise, wherein the CDNX forwards additional messages between the first CDN and the other CDN.

One or more of the preceding embodiments may further comprise, wherein the messages forwarded between the first CDN and the other CDN include at least one of (a) an identification of CDN Interconnection gateways that will terminate a direct interconnection between the CDN and the other CDN and (b) a shared secret that can be used to secure the direct interconnection between the CDN and the other CDN.

One or more of the preceding embodiments may further comprise: storing interconnection descriptors of paths between the first CDN and other CDNs.

One or more of the preceding embodiments may further comprise, wherein each interconnection descriptor comprises at least one of the following information elements: (a) a CDNI-ID of CDN 1 interconnection point; (b) a next hop CDNX towards the other CDN; (c) CDNI-ID of the other CDN interconnection point; and (d) a next hop CDNX towards the other CDN.

One or more of the preceding embodiments may further comprise: relaying bootstrap messages between the first CDN and another CDN for initiating a direct interconnection between the first CDN and the other CDN.

One or more of the preceding embodiments may further comprise: exchanging logs between the first CDN 1 and the other CDN via the CDNX.

One or more of the preceding embodiments may further comprise dynamically updating a path for log exchange between the first CDN and the other CDN.

One or more of the preceding embodiments may further comprise, wherein the dynamic updating of the path for log exchange between the first CDN and the other CDN comprises: sending a new interconnection bootstrap message related to the interconnection; and storing a path between the first CDN and the other CDN based on a bootstrap exchange between the first CDN and the other CDN responsive to the new interconnection bootstrap message.

In another embodiment or in connection with one or more of the preceding described embodiments, a method for a Content Data Network Exchange (CDNX) to facilitate interconnections between two Content Data Networks (CDNs) via a plurality of interconnected Content Data Network Exchanges (CDNXs), comprises: sending a request to a first CDN interconnected to the CDNX requesting an interconnection policy advertisement message from the first CDN; receiving from the first CDN an advertisement disclosing policies for peering with the first CDN; responsive to receipt of the advertisement, storing a discovery entry disclosing the policies for peering with the first CDN in association with an identity of the first CDN; receiving from another CDN a discovery request message including interconnection policies of the other for peering with other CDNs; responsive to receipt of the discovery request, checking if the discovery entry for the first CDN meets the interconnection policies of the other CDN; and if the first CDN meets the interconnection policies of the other CDN, sending a message to the first CDN requesting the first CDN to interconnect with the other CDN.

One or more of the preceding embodiments may further comprise: receiving from the first CDN at least one interconnection bootstrap message for establishing parameters for a direct interconnection between the first CDN and the other CDN; and forwarding the at least one interconnect bootstrap message toward the other CDN.

One or more of the preceding embodiments may further comprise: receiving other interconnection policy advertisement messages from other CDNXs to which the CDNX is interconnected containing policies for peering with CDNs interconnected with the other CDNXs.

One or more of the preceding embodiments may further comprise: storing discovery entries corresponding to the interconnection policy advertisements received from other CDNXs.

One or more of the preceding embodiments may further comprise: associating with each discovery entry next hop information disclosing the identity of a next CDN or CDNX in a path toward the CDN to which the discovery entry corresponds.

One or more of the preceding embodiments may further comprise, wherein the at least one interconnection bootstrap message includes at least one of (a) an identification of CDN Interconnection gateways that will terminate a direct interconnection between the first CDN and the other CDN and (b) a shared secret that can be used to secure the direct interconnection between the first CDN and the other CDN.

One or more of the preceding embodiments may further comprise: exchanging logs between the first CDN and the other CDN via the CDNX.

In another embodiment or in connection with one or more of the preceding described embodiments, a method for a User Equipment (UE) to obtain content from a Content Data Network (CDN) via a Content Data Network Exchange (CDNX) comprises: sending a content request message to a first CDN, the content request including information disclosing the identity of a second CDN as a preferred CDN for content delivery; and receiving the requested content from the first CDN via the second CDN.

One or more of the preceding embodiments may further comprise, wherein the information disclosing the identity of the second CDN is part of a URL in the content request message.

One or more of the preceding embodiments may further comprise, wherein the information disclosing the identity of the second CDN is an HTTP header.

One or more of the preceding embodiments may further comprise, wherein the information disclosing the identity of the second CDN is part of a DNS query

One or more of the preceding embodiments may further comprise, wherein the information disclosing the identity of the second CDN and the content request are contained in separate messages to the first CDN.

In another embodiment or in connection with one or more of the preceding described embodiments, a method for a first Content Data Network (CDN) having a CDN-CDNX connection with a first Content Data Network Exchange (CDNX) to deliver content to a User Equipment (UE) comprises: receiving a content request message to a first CDN, the content request including information disclosing the identity of a second CDN as a preferred CDN for content delivery; and transmitting the requested content to the UE via the preferred CDN.

One or more of the preceding embodiments may further comprise, prior to transmitting the requested content to the UE via the preferred CDN, responsive to receiving the content request message, conducting a bootstrap procedure for initiating an interconnection with the preferred CDN via the first CDNX; and initiating a direct interconnection with the preferred CDN based on the bootstrap procedure.

One or more of the preceding embodiments may further comprise transmitting a message to the UE redirecting the UE to expect to receive the requested content from the preferred CDN.

What is claimed:

1-80. (canceled)

81. A method for a first Content Data Network (CDN) having a CDN-CDNX connection with a first Content Data Network Exchange (CDNX) to interconnect with other CDNs having CDN-CDNX connections with the first CDNX or other CDNXs, the method comprising:
sending a first message to the first CDNX, the first message comprising an advertisement of policies of the first CDN for peering with other CDNs;
conducting a bootstrap procedure, via the first CDNX, for initiating an interconnection with a second CDN; and
initiating a direct interconnection with the second CDN based on the bootstrap procedure.

82. The method of claim 81 further comprising:
sending a second message to the first CDNX comprising a discovery request seeking other CDNs that meet CDN interconnection policies of the first CDN for peering with other CDNs; and
receiving a third message, responsive to the second message, from the first CDNX comprising a discovery request response comprising an identity of at least one other CDN that meets the policies of the first CDN for peering with other CDNs.

83. The method of claim 82 wherein the discovery request response further comprises cost information for the services of CDNXs in a path between the first CDN and the at least one other CDN.

84. The method of claim 82 further comprising:
selecting at least one other CDN identified in the discovery request response; and
commencing a CDN Interface (CDNI) interconnection with the selected at least one other CDN.

85. The method of claim 81 wherein the bootstrap procedure comprises;
sending an interconnect bootstrap message to the second CDN via the first CDNX indicating a desire to interconnect; and
receiving from the second CDN via the first CDNX a response to the interconnect bootstrap message;
wherein the interconnection bootstrap message comprises at least one of the following information elements: (a) type; (b) message source identifier and message destination identifier; and (c) the full path between the first CDN and the second CDN.

86. The method of claim 81 further comprising:
receiving from the first CDNX a fourth message comprising an advertisement of policies of a third CDN for peering with other CDNs;
storing a discovery entry corresponding to the fourth message;
wherein the discovery entry comprises information disclosing the policies for peering with the third CDN in association with an identity of the third CDN and next hop information disclosing the identity of a next CDN or CDNX in a path toward the third CDN.

87. A method for a first Content Data Network Exchange (CDNX) to facilitate interconnections between Content Data Networks (CDNs) via a plurality of interconnected CDNXs, the method comprising:
receiving from a first CDN an interconnection policy advertisement message disclosing policies for peering with the first CDN;
storing a discovery entry disclosing the policies for peering with the first CDN in association with an identity of the first CDN, the discovery entry including a path descriptor for a path between CDNs based on the interconnection policy advertisement messages received by the first CDNX; and
transmitting an interconnection policy advertisement message to at least one other CDNX to which the first CDNX is interconnected advertising the peering policies of the first CDN.

88. The method of claim 87 further comprising:
receiving other interconnection policy advertisement messages from other CDNXs containing policies for peering with CDNs interconnected with the other CDNXs;
storing discovery entries corresponding to the interconnection policy advertisements received from other CDNXs; and
associating with each discovery entry next hop information disclosing the identity of a next CDN or CDNX in a path toward the CDN to which the discovery entry corresponds.

89. The method of claim 88 further comprising:
receiving from the first CDN a discovery request message seeking the identity of other CDNs that meet the first CDN's interconnection policies for peering with other CDNs;
checking the discovery entries to determine if any meet the first CDN's interconnection policies; and
sending a response message to the first CDN comprising the identity of other CDNs meeting the policies of the first CDN.

90. The method of claim 89 further comprising:
forwarding additional messages between the first CDN and the other CDN;
wherein the additional messages forwarded between the first CDN and the other CDN include at least one of (a) an identification of CDN Interconnection gateways that will terminate a direct interconnection between the CDN and the other CDN and (b) a shared secret that can be used to secure the direct interconnection between the first CDN and the other CDN.

91. The method of claim 88 further comprising:
receiving an interconnect bootstrap message from the first CDN identifying another CDN with which the first CDN desires to interconnect; and
forwarding the interconnect bootstrap message toward the other CDN.

92. The method of claim 91 further comprising:
relaying bootstrap messages between the first CDN and the other CDN for initiating a direct interconnection between the first CDN and the other CDN.

93. The method of claim 88 further comprising:
storing interconnection descriptors of paths between the first CDN and other CDNs;
wherein each interconnection descriptor comprises at least one of the following information elements: (a) a CDNI-ID of the first CDN interconnection point; (b) a next hop CDNX towards the other CDN; (c) CDNI-ID of the other CDN interconnection point; and (d) a next hop CDNX towards the other CDN.

94. The method of claim 87 further comprising;
including in the interconnection policy advertisement message that is sent to at least one other CDNX additional information comprising at least cost information for the services of the first CDNX.

95. A method for a first Content Data Network Exchange (CDNX) to facilitate interconnections between two Content Data Networks (CDNs) via a plurality of interconnected Content Data Network Exchanges (CDNXs), the method comprising:
sending a request to a first CDN having a CDN-CDNX connection with the first CDNX requesting an interconnection policy advertisement message from the first CDN;
receiving from the first CDN an advertisement disclosing policies for peering with the first CDN;
responsive to receipt of the advertisement, storing a discovery entry disclosing the policies for peering with the first CDN in association with an identity of the first CDN; receiving from a second CDNX a discovery request message including interconnection policies of a second CDN having a CDN-CDNX connection with the second CDNX for peering with other CDNs;
responsive to receipt of the discovery request, checking if the discovery entry for the first CDN meets the interconnection policies of the second CDN; and
if the first CDN meets the interconnection policies of the other CDN, sending a message to the first CDN requesting the first CDN to interconnect with the other CDN.

96. The method of claim 95 further comprising:
receiving from the first CDN at least one interconnection bootstrap message for establishing parameters for a direct interconnection between the first CDN and the other CDN; and
forwarding the at least one interconnect bootstrap message toward the other CDN.

97. The method of claim 96 further comprising:
receiving other interconnection policy advertisement messages from other CDNXs to which the first CDNX is interconnected containing policies for peering with CDNs interconnected with the other CDNXs;
storing discovery entries corresponding to the interconnection policy advertisements received from other CDNXs; and
associating with each discovery entry next hop information disclosing the identity of a next CDN or CDNX in a path toward the CDN to which the discovery entry corresponds.

98. A method for a Content Data Network (CDN) having a CDN-CDNX connection with a first Content Data Network Exchange (CDNX) to interconnect with other CDNs having CDN-CDNX connections with other CDNXs, the method comprising:
discovering a second CDN with which to peer, the second CDN having a CDN-CDNX interconnection with a second CDNX;
conducting a bootstrap procedure for initiating an interconnection with the second CDN via the first CDNX; and
initiating a direct interconnection with the second CDN based on the bootstrap procedure.

99. The method of claim 98 wherein the bootstrap procedure comprises;
sending an interconnect bootstrap message to the second CDN via the first and second CDNXs, the interconnect bootstrap message indicating a desire to interconnect; and
receiving from the second CDN via the first and second CDNXs a response to the interconnect bootstrap message.

100. The method of claim 99 wherein the first CDN and the second CDN further exchange additional information via at least the first and second CDNXs comprising at least one of (a) an identification of CDN Interconnection gateways that will terminate a direct interconnection between the first CDN and the second CDN and (b) a shared secret that can be used to secure the direct interconnection between the first CDN and the second CDN.

101. The method of claim 99 wherein the interconnection bootstrap message comprises at least one of the following information elements: (a) type; (b) message source identifier and message destination identifier; and (c) the full path between the CDN and the other CDN.
